(19) United States
(12) Patent Application Publication
(10) Pub. No.: US 2025/0305863 A1
(43) Pub. Date: Oct. 2, 2025

(54) DOSING VALVE FOR A DOSING DEVICE

(71) Applicants: VERMES MICRODISPENSING GMBH, Holzkirchen (DE); IPR Intelligente Peripherien für Roboter GmbH, Eppingen (DE)

(72) Inventors: Andreas STEINHAUSER, München (DE); Mario FLIESS, München (DE); Thomas GINZEL, Kreuth-Weissach (DE); Selin ÖZTOPRAK, Flein (DE); Helge SCHNEIDER, Brackenheim (DE)

(73) Assignees: VERMES MICRODISPENSING GMBH, Holzkirchen (DE); IPR Intelligente Peripherien für Roboter GmbH, Eppingen (DE)

(21) Appl. No.: 18/865,288

(22) PCT Filed: May 11, 2023
(86) PCT No.: PCT/EP2023/062647

§ 371 Date: Nov. 12, 2024

(30) Foreign Application Priority Data
May 12, 2022 (DE) 10 2022 111 988.2

(51) Int. Cl. G01F 11/00; G01F 11/30

(52) U.S. Cl. CPC G01F 11/006; G01F 11/30

(57) ABSTRACT

The invention concerns a dosing unit (1) with at least one dosing device (2), the dosing device (2) having at least one dosing system (3) with at least one dosing valve (4) for the delivery of a dosing material, and with at least one exchange system (5) associated with the dosing device (2). The dosing unit (1) is configured and can be controlled by a control device (6) in a manner such that, in an automated process, at least the dosing valve (4) can be detachably coupled with the dosing device (2) for the purposes of delivering dosing material via the exchange system (5) and/or in a manner such that, in an automated process, at least the dosing valve (4) can be detachably coupled with a supply device (7) via the exchange system (5).

The invention furthermore concerns an exchange system (5) for a dosing unit (1), a dosing device (2) for a dosing unit (1) and a dosing system (3) with a dosing valve (4) as well as a dosing valve (4) for a dosing system (3). Furthermore, the invention concerns a method for the automated coupling of at least one dosing valve (4) with a dosing device (2) and/or with a supply device (7).

The invention relates to a dosing unit with at least one dosing device, the dosing device having at least one dosing system with at least one dosing valve for delivering a dosing material, and with at least one exchange system associated with the dosing device. The invention relates to an exchange system and a dosing device for a dosing unit as well as a dosing system and a dosing valve for a dosing system. The invention also relates to a method for the automated coupling of at least one dosing valve with a dosing device and/or with a supply device.

Dosing systems of the type mentioned above are typically used in order to apply a medium to be dispensed onto a target surface in a systematic manner, i.e. at the right time, at the right location and in a precisely metered quantity. A dosing system usually comprises at least one dosing valve which serves for the actual delivery of the dosing material and other elements depending on the configuration, for example a controller for operating the dosing valve and a dosing material reservoir. The delivery of the dosing material can be carried out by means of a dropwise delivery of a dosing medium or dosing material via a nozzle of the dosing valve. A dosing valve can also be described as a dosing head of a dosing system, depending on the configuration.

In the context of what is known as “microdosing technology”, it is often necessary for very small quantities of a dosing material to be placed on the target surface with pinpoint accuracy and indeed in a contact-free manner, i.e. without direct contact between the dosing system and a target surface. A typical example of this is dosing dots of glue, soldering paste, paint etc when fitting out printed circuit boards or other electronic elements, or the application of converter materials for LEDs.

Such a contact-free method is often described as a “Jet process”, wherein a dosing valve operating in accordance with the jet process is known as a “jet valve”. The dosing medium is usually delivered from the jet valve by disposing a movable ejection element in the interior of a nozzle of the jet valve which is moved at a relatively high speed in an ejection direction onto a nozzle opening, whereupon a single droplet of the medium is ejected from the nozzle. After the completion of such an ejection procedure, the ejection element is pulled back in an opposite rearwards direction in order to eject a subsequent droplet.

As an alternative or in addition to a movable ejection element, in order to deliver a dosing material, a nozzle of a jet valve can itself be moved in an ejection or rearwards direction. In order to deliver the dosing material, the nozzle and an ejection element disposed inside the nozzle can be moved in a relative movement towards or away from each other, wherein the relative movement can be accomplished either solely by a movement of the nozzle or at least partially by a corresponding movement of the ejection element as well.

Instead of a jet valve, a dosing system as mentioned above for delivering dosing material can also comprise a contact dosing valve. Furthermore, a dosing valve can also be produced as a needle dosing valve. Accordingly, the invention is also not restricted to a specific type of dosing valve, but can be of application in any currently known dosing valves or dosing systems of the type mentioned above, even though the jet valve described above is preferred.

During operation of a dosing system, it is frequently necessary for specific components of the dosing system, in particular of the dosing valve, to have to be cleaned and/or exchanged at regular intervals or if a malfunction is reported. As an example, depending on the quality of a dosing material, regular cleaning of the fluid-conducting parts of the dosing valve can be necessary in order to ensure a constant dosing result during operation. In addition, a change of the fluid-conducting elements of the dosing valve before changing the dosing material can be necessary. In the case of dosing valves which are equipped with their own reservoir of dosing material, during operation, a regular exchange of a dosing material cartridge can be necessary.

In order to obtain a specific dosing pattern, in particular in order to produce a product with a specific pattern of dosing material, during operation, a change in the configuration of a dosing system, in particular of a dosing valve, can be necessary. A configuration of a dosing valve can, for example, involve a setup of a nozzle and/or an ejection element and/or an actuator and/or a property of the dosing material.

Particularly in the case of the aforementioned jet valves, during operation, it is necessary for specific components, for example components which are subject to a lot of wear during operation, have to be exchanged or swopped for maintenance purposes, in order to obtain a constant dosing result.

In known dosing systems, an exchange of a specific component usually means that an entire dosing system, at least an entire dosing valve of the dosing system, has to be removed from a superordinated unit. To do this, the dosing valve is manually dismantled from the superordinated unit, for example by an operative, and replaced with another dosing valve, wherein frequently, adjustment of the dosing valve still has to be carried out by hand. Depending on the configuration of the dosing valve, a great deal of time can be spent on exchanging a dosing valve, wherein accordingly, a manufacturing process is also interrupted.

Particularly in the case of large production units, in which a plurality of dosing valves are integrated into a superordinated unit and operated from it, exchanging only one of the dosing valves can lead to temporary stoppage of the entire production unit.

In addition, a regular exchange and/or an exchange which is dictated by the situation of specific, for example worn, components of a dosing valve is necessary during operation with regard to a constant dosing result.

An objective of the present invention is to provide a dosing unit and the assemblies or dosing unit components necessary for an operation of the dosing unit with which the aforementioned disadvantages can be overcome or at least alleviated and with which a dosing system or a dosing valve can be operated as efficiently as possible.

This objective is achieved by means of a dosing unit in accordance with patent claim 1, an exchange system in accordance with claim 5, a dosing device in accordance with claim 6, a dosing valve in accordance with claim 7 and a dosing system in accordance with claim 14, as well as by a method in accordance with claim 15.

A dosing unit in accordance with the invention has at least one dosing device, the dosing device having at least one dosing system for a dosing material or a dosing medium during operation.

In the context of the invention, a “dosing device” should be understood to mean a superordinated assembly or entity which comprises at least (preparation) means, so that an intended dosing material delivery can be carried out by at least one dosing valve, preferably a dosing system, coupled with the dosing device. Preferably, the dosing device can comprise at least a supply device and/or a control device. At least a single, preferably two or more dosing valves during operation, i.e. for the intended delivery of dosing material, can be coupled with the dosing device. The respective dosing valves or dosing systems are preferably configured so as to be separately controllable. Preferably, each dosing valve which is in operative contact with a dosing device by means of a coupling in order to deliver dosing material, forms a dosing entity which is to be operated separately.

Irrespectively of the specific embodiment, a dosing device can comprise at least one, preferably a plurality of coupling positions for detachably coupling a respective dosing valve, preferably a dosing system. Preferably, a mating interface portion can be associated with each coupling position in order to form an interface between the dosing device and a respective dosing valve. This will be described in detail below.

A dosing system in accordance with the invention comprises at least one dosing valve which is configured so that during operation, a dosing material is delivered onto a substrate in a controlled manner. The dosing valve can be configured in accordance with one of the aforementioned types. In particular, the dosing valve can be a jet valve. The dosing valve has at least one actuator unit and a fluidic unit which is coupled with it during operation and which cooperates with it functionally as sub-components. The dosing valve comprises at least the components of a dosing system, which contribute to the actual dosing material delivery during operation. In particular, the dosing valve can be configured as a subunit of a dosing system.

In addition to a dosing valve, a respective dosing system has at least one further dosing material reservoir and an associated control device for controlling the operation of the dosing valve. The dosing material reservoir and/or the control device can be associated with a specific dosing valve, in particular built onto it and/or into it, for example as an entrained dosing material cartridge or as a local control unit. Alternatively or in addition, a dosing valve can be coupled during operation with an external, in particular stationary, dosing material reservoir and/or with a superordinated, in particular external control device, in order to form a dosing system. Details of the dosing system will be provided below.

In accordance with the invention, the dosing unit comprises at least one exchange system which is associated with the dosing device at least temporarily during operation. In particular, during operation of the dosing unit, the exchange system can be at least temporarily associated with a specific dosing system and/or a specific dosing valve. Depending on the embodiment, at least parts of the exchange system can be permanently associated with a specific dosing valve for the purposes of delivering dosing material.

In accordance with the invention, the dosing unit, in particular the exchange system and/or the dosing device and/or the dosing valve, is configured and therefore can be controlled by a control device in a manner such that, in an automated process, at least the dosing valve can be detachably coupled, in particular is reversibly coupled, with the dosing device via the exchange system, in particular via a movable exchange device of the exchange system, for the purposes of delivering dosing material.

In accordance with one embodiment, a (respective) dosing valve can be disposed for coupling directly to the dosing device itself, wherein in the coupled state, an intended delivery of dosing material can be carried out via the dosing valve.

In accordance with one embodiment, as an alternative or in addition, a dosing valve can be indirectly connected to the dosing device for coupling. Preferably, such an (indirect) coupling can be made by means of a movable exchange device of the exchange system. As an example, a movable exchange device can be permanently associated with a specific dosing valve in the dosing operation, wherein on the one hand, the exchange device is detachably coupled with the dosing valve and on the other hand, it is in operative contact with the dosing device. Accordingly, the dosing valve can also be coupled with the dosing device via the coupling with the movable exchange device. A combination of the two embodiments is also possible. As an example, a dosing unit can have at least one dosing valve which is disposed directly on a dosing device for delivering dosing material, wherein at least one other dosing valve for delivering dosing material is detachably coupled with a movable exchange device.

As an alternative or in addition, the dosing unit, in particular the exchange system and/or the dosing device and/or the dosing valve, is configured and can be controlled by a control device in a manner such that, in an automated process, at least the dosing valve can be detachably coupled, in particular is reversibly coupled, to a supply device via the exchange system.

In accordance with one embodiment, at least one dosing valve can be disposed for coupling directly or straight to the supply device itself. As an alternative or in addition, at least one dosing valve can be (indirectly) coupled via a movable exchange device with the supply device, wherein the dosing valve is coupled with the exchange device and wherein the exchange device is in operative contact with the supply device. A combination thereof is also possible.

A supply device can be configured as part of the dosing device, wherein the dosing valve can then be detachably coupled with the supply device via the dosing device.

As an alternative or in addition, a, preferably separately configured, supply device can be connected to a magazine which is part of the exchange system, wherein the dosing valve can then be detachably coupled with the supply device via the magazine. As an alternative or in addition, a supply device can preferably be separately constructed from the dosing device, wherein the dosing valve can (only) be coupled with the supply device via the exchange system, for example during a transportation of the dosing valve in the dosing unit. Irrespectively of the specific embodiment of the supply device, the (respective) dosing valve can be coupled with the supply device directly or indirectly, for example via a movable exchange device, in particular in an automated process.

The term “automated process” should be understood to mean that preferably, a procedure for coupling the dosing valve can be carried out or is carried out as intended without direct manual intervention of a human being. The individual steps of the method which form the basis of the automated coupling process and/or the means involved in the coupling process can be controlled by a control device, in particular by a superordinated control device of the dosing unit, so that a coupling procedure for coupling the dosing valve and/or an uncoupling procedure for uncoupling the dosing valve is carried out fully automatically.

To couple at least the dosing valve with the dosing device and/or with the supply device, the exchange system, in particular a movable exchange device, can at least temporarily interact functionally with the dosing device and/or with at least parts of the dosing valve. In particular, the exchange system provides means which are configured in order thereby, in particular by an interaction with the dosing device and/or with the dosing valve, to couple at least one dosing valve with the dosing device and/or with the supply device by means of coupling. Accordingly, the exchange system preferably also provides means for carrying out an uncoupling of at least the dosing valve from the dosing device and/or from the supply device thereby.

In accordance with the invention, the exchange system is configured in order, in an automated process, to detachably couple at least one dosing valve with an associated coupling partner. Accordingly, in the automated process, a (complete) dosing system can be formed via the exchange system, in particular by means of coupling of a dosing valve with a dosing device comprising an associated control device and an associated dosing material reservoir. Furthermore, the exchange system is also configured in order, in an automated process, to detachably couple a (complete) dosing system with the dosing device and/or with the supply device, in particular insofar as the dosing valve has a local control unit and an entrained dosing material reservoir.

Advantageously, via a dosing unit in accordance with the invention with a dosing device and with an appropriately constructed dosing valve cooperating with the exchange system, both a coupling of a dosing valve with a dosing device as well as an uncoupling can be carried out in a fully automated process. As an example, control software to control the coupling or uncoupling process can be manually set up, wherein then, the actual exchange process in the dosing unit can be carried out without the direct participation of an operator via a control device.

Advantageously, by means of the dosing unit in accordance with the invention and the other dosing unit components, an exchange of a dosing valve can be carried out more rapidly than with a manual exchange, so that the dosing operation is interrupted as little as possible. Particularly in the case of large production units with a plurality of dosing valves, stoppages of the dosing unit can be reduced, whereupon the efficiency of the dosing unit is improved. Furthermore, by means of the automated exchange process, sources of human error when changing the dosing valves can be reduced, enhancing the production quality.

A further advantage arises from the fact that a dosing valve which is uncoupled from the dosing device can be brought into operative contact with a supply device via the exchange system. Advantageously, in the case of a dosing valve which is not in dosing operation, cleaning and/or tempering can be carried out and/or the dosing valve can be controlled by a control device, in particular for a calibration and for dosing valve teaching processes, via the supply device. This will be described in more detail below.

The invention furthermore concerns an exchange system for a dosing unit, in particular for a dosing unit in accordance with the invention, wherein the dosing unit has at least one dosing device with at least one dosing system during operation, the dosing system having at least one dosing valve, preferably a dosing valve as described above. In accordance with the invention, the exchange system is configured and controllable from a control device so that at least the dosing valve of the dosing system can be detachably coupled with the dosing device in an automated process via the exchange system for the purposes of delivering dosing material and/or so that, in an automated process, at least the dosing valve can be detachably coupled, in particular is respectively reversibly coupled, with a supply device via the exchange system.

The exchange system is preferably configured and controllable by the control device in a manner such that, in an automated process, at least the dosing valve of the dosing system can be uncoupled from the dosing device and/or from the supply device via the exchange system.

Preferably, the exchange system has at least one mating interface portion which is configured to detachably couple the dosing valve with the exchange system in an automated process, by cooperation with an associated valve interface portion of the dosing valve with the formation of an interface.

In accordance with one embodiment, the exchange system can have at least one, preferably two or more separately controllable movable exchange devices. Preferably, a respective exchange device has a mating interface portion which is complementary to the valve interface portion. More preferably, a respective movable exchange device can be in operative contact with the dosing device and/or the supply device, wherein, in an automated process, a dosing valve can be detachably coupled with the movable exchange device via the respective mating interface portion. Accordingly, a dosing valve can also be (indirectly) coupled with the dosing device and/or the supply device via the coupling with a movable exchange device. In other words, in order to couple the dosing valve with the dosing device and/or with the supply device by means of the movable exchange device, an operative connection between the dosing valve and the dosing device and/or the supply device can be formed. This means that the (respective) movable exchange device can provide a mating interface portion, the mating interface portion being associated with the dosing device and/or the supply device.

Preferably, a respective movable exchange device in accordance with this embodiment can form an intermediate element or a connecting element between a dosing valve and a dosing device or supply device and is therefore also described as a movable intermediate member.

Preferably, a movable intermediate member can be formed by means of a controllable robotic arm with a mating interface portion. Preferably, a portion of the robotic arm can be disposed in the dosing unit in a stationary manner, for example via a secure connection with the dosing device or a supply device, wherein a second portion of the same robotic arm is movable, in particular with respect to a magazine and/or the dosing device and/or a dosing point. A movable intermediate member of this type in accordance with this embodiment is known as a “work manipulator”. Preferably, two or more work manipulators which are to be operated separately (as part of the exchange system) can be associated with one dosing device.

The invention furthermore concerns a dosing device for a dosing unit, in particular for a dosing unit in accordance with the invention, wherein during operation, the dosing device has at least one dosing system with at least one dosing valve, preferably a dosing valve as described above, and wherein the dosing device is configured and can be controlled by a control device in a manner such that, in an automated process, at least the dosing valve of the dosing system can be detachably coupled with the dosing device via an exchange system of the dosing unit for the purposes of delivering dosing material, and/or in a manner such that, in an automated process, at least the dosing valve can be detachably coupled with a supply device via the exchange system of the dosing unit, in particular is respectively reversibly coupled therewith.

The dosing device is preferably configured and can be controlled by the control device in a manner such that, in an automated process, at least the dosing valve of the dosing system can be uncoupled from the dosing device and/or from the supply device via the exchange system of the dosing unit. Preferably, the coupling and/or uncoupling of a dosing valve can be carried out via a movable exchange device of the exchange system, preferably a work manipulator.

The invention further concerns a dosing valve for a dosing system, in particular for a dosing unit in accordance with the invention. Preferably, the dosing valve comprises at least one actuator unit and a fluidic unit, in particular detachably coupled therewith. A dosing valve of this type which is constructed from an actuator unit and a fluidic unit can also synonymously be described as a dosing head of a dosing system.

Preferably, the actuator unit has at least one actuator for moving an ejection element of the dosing valve for delivering dosing material. Preferably, the actuator can be a pneumatic actuator. A pneumatic actuator can preferably comprise a membrane which can be pressurised and/or deflected by means of a pressure medium, in order thereby to move an ejection element in an ejection direction. Preferably, the actuator can be a piezo actuator. Alternatively, an electromagnetic drive or a combination of different actuator types can be provided as the form of drive. The fluidic unit comprises at least a feed channel for dosing material and a nozzle for delivering dosing material out of the dosing valve. The fluidic unit and/or the actuator unit can preferably have at least one heating device for temperature control of the dosing material. Details of the actuator unit and the fluidic unit are provided below.

In accordance with the invention, the dosing valve has at least one valve interface portion which is configured in order, in an automated process, to detachably couple the dosing valve, in particular with the formation of an interface, by cooperation with an associated mating interface portion which is associated with a dosing device, and/or by cooperation with an associated mating interface portion which is associated with a supply device, for delivering dosing material with the dosing device and/or with the supply device. The valve interface portion and the mating interface portion are in particular configured in a manner such that with the formation of an interface, the dosing valve can be detachably connected with the dosing device in the automated process, for example detachably disposed thereon, for an intended delivery of dosing material.

The valve interface portion can at least partially be configured as part of the dosing valve itself, in particular as an integral component. As an alternative or in addition, the valve interface portion can be at least partly disposed on the dosing valve. As an alternative or in addition, the valve interface portion can be formed at least in part on a housing and/or can be formed as part of a housing, the housing partially or completely surrounding the dosing valve. Preferably, the valve interface portion can be in the form of an interface module.

The valve interface portion is preferably formed in multiple parts. In particular, the valve interface portion can comprise two or more elements (described as valve interface elements). The respective valve interface elements, in particular the respective coupling elements formed thereof, can be formed separately, for example spatially separated from each other.

The mating interface portion is preferably formed in multiple parts. In particular, the mating interface portion can comprise two or more elements (described as mating interface elements). The respective mating interface elements or regions can be formed separately, for example spatially separated from each other.

In accordance with one embodiment, at least one mating interface element of the mating interface portion which is associated with a dosing device and/or a supply device can be formed at least in sections as part of the dosing device itself and/or can be disposed at least in sections on the dosing device.

In accordance with one embodiment, as an alternative or in addition, at least one mating interface element of the mating interface portion which is associated with a dosing device and/or a supply device can be provided by the exchange system, in particular a movable exchange device.

Furthermore, at least one mating interface element of the mating interface portion which is associated with a supply device can be formed at least in sections as part of the supply device itself and/or can be disposed at least in sections on the supply device. As an alternative or in addition, a mating interface element can also be provided by a magazine of an exchange system. Details in this regard will be provided below.

In accordance with the invention, the dosing valve has at least one coupling region which is configured to interact with an exchange system which is at least temporarily associated with the dosing valve in order to couple the dosing valve with the dosing device and/or in order to couple the dosing valve with the supply device in an automated process. Preferably, the exchange system is an exchange system of a dosing unit in accordance with the invention as described above. The exchange system is associated with a specific dosing valve, at least for the time period for the exchange of the respective dosing valve. The exchange system can alternately be associated with different dosing valves and/or different dosing devices.

The coupling region on the dosing valve is preferably configured in a manner such that the exchange system can interact with the dosing valve via this coupling region, in particular can act on it in a manner such that the dosing valve and the dosing device and/or the dosing valve and the supply device are brought into operative contact. The coupling region is more preferably configured in a manner such that the exchange system can interact with the dosing valve thereby in a manner such that an uncoupling of the dosing valve from the dosing device and/or an uncoupling of the dosing valve from the supply device can also be carried out in the automated process.

Preferably, the coupling region of the dosing valve can be configured as part of the valve interface portion. In principle, a dosing valve can have two or more, even different, coupling regions.

In accordance with one embodiment, the coupling region can be configured in the form of a transport coupling element of the valve interface portion. The valve interface portion is then preferably configured in order, in an automated process, to detachably couple the dosing valve with an exchange system, in particular with the formation of an interface, by co-operation with an associated mating interface portion of the exchange system, in particular for a transport of the dosing valve in the dosing unit.

In this embodiment, the valve interface portion can be formed in at least three parts. Preferably, the valve interface portion then comprises three valve interface elements, wherein one valve interface element forms a supply coupling element and wherein a (another) valve interface element forms a function coupling element and wherein a (another) valve interface element forms a transport coupling element. The valve interface portion is preferably configured in a manner such that the dosing valve simultaneously forms a (single) interface via two or more valve interface elements. Accordingly, an interface, in particular as a function of the valve interface elements involved, can have different configurations and/or can comprise two or more interface segments. Details in this regard will be provided below.

In accordance with one embodiment, the valve interface portion can have two valve interface elements, wherein one valve interface element forms a supply coupling element and wherein another valve interface element forms a function coupling element. Preferably, the coupling region of the dosing valve can then be formed by the function coupling element of the valve interface portion. Preferably, the dosing valve can also interact with the exchange system during the dosing operation via the coupling region, in particular being detachably disposed on a movable exchange device, wherein the dosing valve can be coupled with the dosing device and/or with the supply device via the movable exchange device.

The invention further concerns a dosing system for a dosing device of a dosing unit, in particular for a dosing unit in accordance with the invention. The dosing system has at least one dosing valve, in particular a dosing valve in accordance with the invention, and an associated control device for controlling the dosing valve. The control device can be a control device of the dosing unit and/or a control unit belonging to the dosing system, for example a (local) control unit. The dosing system is configured and can be controlled by the control device in a manner such that, in an automated process, at least the dosing valve can be detachably coupled with the dosing device for the purposes of delivering dosing material via an exchange system of the dosing unit, in particular via an exchange system in accordance with the invention, and/or in a manner such that, in an automated process, at least the dosing valve can be detachably coupled with a supply device via the exchange system.

Furthermore, the dosing system can preferably be controlled from the associated control device in a manner such that, in an automated process, at least the dosing valve of the dosing system can be uncoupled from the dosing device and/or from the supply device via the exchange system of the dosing unit.

Advantageously, all of the assemblies of a dosing unit or dosing unit components have the same underlying inventive concept, which is to be able to exchange a dosing valve of a dosing system in an automated process. Consequently, the same advantageous effects as those which have been described for the dosing unit in accordance with the invention also apply in the same manner for a dosing device, an exchange system, a dosing system and a dosing valve.

In a method in accordance with the invention for the automated coupling of at least one dosing valve with a dosing device and/or with a supply device, preferably a dosing valve in accordance with the invention and/or a dosing valve for a dosing unit in accordance with the invention, the automated coupling preferably comprises at least one exchange of a dosing valve. Preferably, the automated coupling can be carried out during operation of a dosing unit, in particular while at least one other dosing system of the same dosing unit continues the dosing operation.

The method can comprise at least the following steps:

In an optional step, at least one interface of a mounted dosing valve, the interface having a valve interface portion and a mating interface portion, can be brought into a transfer status of the interface in order to enable an automated exchange of the dosing valve which has the valve interface portion. Preferably, the transfer status is induced by shutting off the power and/or pressure of at least one (interface) element of at least one interface portion.

Preferably, the power and/or pressure for a supply coupling can be shut off. In particular, the transfer status of the interface can be produced via commands from a control device which is associated with the dosing valve, preferably superordinated.

In an optional step, the dosing valve can be transferred into an exchange system, preferably by using a coupling region of the dosing valve associated with the exchange system. Preferably, the dosing valve can be transferred into a movable exchange manipulator of the exchange system.

In an optional step, the interface can be transferred into an uncoupling status, preferably by means of the control device associated with the dosing valve. In order to transfer into the uncoupling status, a preferably mechanical coupling between the valve interface portion and the mating interface portion can be released; in particular, a function coupling can be opened.

In an optional step, the detached or uncoupled dosing valve can be transferred into a magazine, preferably into a magazine of the exchange system. Preferably, the transfer can be carried out by means of a movable component of the exchange system, in particular via a movable exchange manipulator. The steps of the method described above can preferably be carried out with a dosing valve which is (directly) coupled with a dosing device and/or a supply device.

As an alternative or in addition, in accordance with one embodiment, firstly, an interface of a mounted dosing valve as described above can be brought into a transfer status, wherein the dosing valve is coupled with a work manipulator as the movable exchange device. Preferably, the dosing valve can be transferred into a magazine of the exchange system by the work manipulator. Next, the interface can be brought into an uncoupling status in order to deposit the uncoupled dosing valve in the magazine. It would also be possible to initially bring the dosing valve into a magazine via the work manipulator in order to produce the transfer status and the uncoupling status of the interface only there.

The optional steps of the method described above are preferably carried out when a dosing valve is to be exchanged, i.e. a dosing valve is replaced by another dosing valve which has an identical function, for example, in the same sequence of the method. In this respect, the method can therefore also be described as a combined uncoupling/coupling method, or more briefly as an “exchange process”. The steps described above therefore do not necessarily have to be carried out in the cited sequence; several steps can essentially be carried out simultaneously, or individual steps can indeed be omitted.

In each case, the method in accordance with the invention comprises the steps of the method described below. Insofar as the method is carried out as an exchange process, these steps of the method can essentially directly follow the uncoupling steps described above.

Alternatively, the following steps can also be carried out independently of the above optional steps, for example when a dosing device is equipped with a dosing valve after a long down-time period.

Initially, a dosing valve is provided with a valve interface portion, preferably by means of an exchange system. “Provision” means at least that the exchange system has access to the dosing valve and in particular can interact with the dosing valve.

In accordance with one embodiment, for the provision, a mating interface portion of the exchange system can interact with the valve interface portion, in particular with a transport coupling element, with the formation of an interface, preferably in order to form a first interface segment of the interface. Then, using the exchange system, the valve interface portion of the dosing valve, in particular a function coupling element and a supply coupling element, is brought together with a mating interface portion which is complementary therewith, which is associated with a dosing device and/or a supply device, in particular in order to form a second interface segment. In this embodiment, the dosing valve can preferably be coupled directly with the dosing device and/or the supply device.

In accordance with one embodiment, a mating interface portion of a work manipulator can interact with the valve interface portion, with the formation of an interface. In this case, the valve interface portion can be brought together with a complementary mating interface portion of the work manipulator, i.e. using the exchange system, wherein the mating interface portion of the work manipulator is associated with the dosing device and/or the supply device.

Irrespectively of the specific embodiment, at least one interface element of the valve interface portion and/or of the mating interface portion which is associated with the dosing device and/or the supply device, is interlocked, preferably by commands through a control device associated with the dosing valve, in order to detachably or reversibly couple the dosing valve, via the valve interface portion, with the mating interface portion which is associated with the dosing device and/or with the mating interface portion which is associated with the supply device for coupling the dosing valve. The coupling can be indirect, wherein the dosing valve can then be reversibly coupled with the dosing device and/or the supply device with the formation of an interface via a work manipulator.

In an optional step, depending on the embodiment, a connection between the mating interface portion of the exchange system and the valve interface portion, in particular the transport coupling element, can be released.

Insofar as the dosing valve is coupled with a movable work manipulator, the previously configured interface can also remain closed, even during the dosing operation of the dosing valve.

In an optional step, an adjustment of an actuator or an actuator unit can be carried out. An adjustment is advantageous having regard to dosing accuracy, in particular in the case of a jet valve with a movable ejection element. Preferably, the adjustment can be carried out in a manner such that in a defined operational state of the actuator, in particular in a deflected operational state of the actuator, a specific compressive force of an ejection element is generated by the actuator onto a nozzle of a fluidic unit. Preferably, the adjustment process can be controlled via a control device which is associated with the dosing valve, preferably superordinated.

Advantageously, the automated exchange method or the automated exchange process is also based on the same inventive concept, as described with respect to the dosing unit. Correspondingly, the same advantageous effects also accrue for this method.

The previously described exchange process can advantageously also be integrated into a method for controlling at least one, preferably a plurality of dosing systems each with a dosing valve, preferably in order to control dosing systems in accordance with the invention. Preferably, the control method can be carried out in a manner such that during operation of the at least one dosing system, an intended delivery of dosing material is made from the dosing valve. Preferably, in the control method, in an automated process, a dosing valve can be coupled at least once to a mating interface portion which is associated with a dosing device and/or a supply device via a valve interface portion, in order to detachably couple the dosing valve with the dosing device and/or with the supply device. Preferably, the control method can be implemented in a manner such that, in an automated process, a dosing valve can be uncoupled at least once from the dosing device and/or from the supply device;

in particular, a dosing valve can be replaced by another dosing valve at least once.

The feature of a “detachable coupling” or “detachable coupling capability” as used in the context of the invention means that the dosing valve and/or an associated coupling partner, in particular the valve interface portion and the mating interface portion, are configured such that they can be coupled together and later can be separated from one another again. This means that the dosing valve, in particular while maintaining its technical specification, can be detached from its coupling partner again. In particular, an uncoupling of a dosing valve and a subsequent coupling of another dosing valve, i.e. a dosing valve exchange, can be carried out in a common process sequence.

Other, particularly advantageous embodiments and further embodiments of the invention are defined in the dependent claims as well as in the description below, wherein the independent claims of one category of claims also pertain analogously to the dependent claims and exemplary embodiments of another category of claims and in particular, individual features of different exemplary embodiments or variations can be combined to form new exemplary embodiments or variations.

A dosing unit as described above comprises at least one, preferably two or more separate dosing devices. A dosing unit can, for example, be an entire production facility and can comprise at least the assemblies or dosing unit components which are necessary for carrying out the invention. This means that a dosing unit preferably comprises at least a respective dosing device, an exchange system, a dosing system, a dosing valve and a control device.

Insofar as a dosing unit has two or more dosing devices, different finished products can be manufactured, for example, on the individual dosing devices. Accordingly, the respective dosing devices can be operated separately from one another and/or be controllable separately from a control device. The dosing devices can be configured differently. As an example, a dosing device can be configured in a manner such that at least one dosing valve is disposed directly on the dosing device for delivering dosing material, wherein another dosing device is coupled with at least one dosing valve via a movable intermediate member for delivering dosing material.

Preferably, a dosing unit can have a control device which can separately control all of the assemblies of the dosing unit, in particular the respective dosing valves. This control device can have all the hardware components, for example interfaces for the individual assemblies of a dosing unit, and can be programmed accordingly, in order to send control signals for an automated coupling and/or uncoupling process to the respective assemblies and/or in order to control a dosing process of the individual dosing valves. A control device of this type can also be described as a “superordinated” control device and may be centralized. However, preferably, a superordinated control device is decentralized in configuration.

As an example, a superordinated control device can comprise a system produced from a plurality of cooperating partial control units which also can be disposed at different positions in a dosing unit. Preferably, the respective partial control units can communicate with each other, in particular in order to exchange control signals and/or measurement signals.

Preferably, a superordinated control device can comprise at least two cooperating partial control units. Preferably, then, a (first) partial control unit can be configured to carry out a control of specific unit functions of the dosing unit, in particular unit functions which do not concern the dosing process itself. Preferably, such a “unit control unit” controls at least positioning a specific dosing valve in the dosing unit and/or handling finished products, in particular transport of finished products to or from a dosing point, and/or carrying out a monitoring function, in particular as regards the dosing precision of a respective dosing valve. This unit control unit can, for example, be produced by means of a standard programmable logic controller (PLC). Preferably, a specific configuration of a dosing unit, in particular a position of assemblies or dosing unit components in the dosing unit, can be stored in the unit control unit.

Preferably, the unit control unit can interact with a (second) partial control unit which controls the actual dosing process of the respective dosing valves of the dosing unit and/or an automated exchange process for a specific dosing valve (hereinafter “operating control unit”). Preferably, the unit control unit and the operating control unit can communicate with each other, in particular in order to exchange control signals. The operating control unit can advantageously control at least the following respective elements of a dosing unit separately: an exchange system, in particular a magazine for dosing valves and a movable exchange device or a (respective) work manipulator, as well as the respective dosing valves of a dosing unit, in particular a valve interface portion of the respective dosing valves and a respective associated mating interface portion.

In principle, it is possible for an exchange process for a dosing valve to be controlled only by the operating control unit.

However, preferably, two or more partial control units cooperate together for the automated exchange of a dosing valve. Preferably, the unit control unit can control the assemblies of a dosing unit which are involved in a manner such that a specific dosing valve (to be exchanged) is brought into an exchange position. In order to carry out the actual exchange process, the operating control unit, preferably as a function of control signals from the unit control unit, controls the assemblies involved in the exchange procedure, i.e. in particular an exchange system and a specific dosing valve as well as the interface portions involved. After the completion of the exchange process, in particular dependent on control signals from the operating control unit, the exchanged dosing valve can be brought back into a working position from the exchange position by means of the unit control unit.

For the sake of completeness, it will be pointed out that in principle, a single, if necessary a central, superordinated control device could also carry out the steps of the method for the automated exchange process as well as control the dosing process for the dosing valves, i.e. in order to control a dosing unit in accordance with the invention in its entirety.

In a non-limiting manner, the description starts from a superordinated control device with at least two cooperating partial control units, because in this way, particular advantages can accrue. As an example, when implementing the invention in an existing dosing unit, a control device which is already present could be called upon so that, for example, only the particular operating control unit for controlling the automated exchange process would have to be retrofitted.

Preferably, a superordinated control device can also have a regulating function. As an example, operating parameters of the respective dosing valves or its sub-components can be fed into the control device and processed therein. Preferably, the superordinated control device can intervene to regulate the dosing operation of a specific dosing valve and/or a specific dosing device taking into consideration at least one operating parameter, so that a nominal value for the operating parameter is obtained. Such an operating parameter could, for example, be an actuator deflection or a plunger stroke during operation.

Preferably, the superordinated control device can be configured to continuously actively monitor at least one status value during operation of the dosing unit, preferably of at least one component, of a dosing system, in particular of a dosing valve. Such a status value can, for example, be a wear parameter, a temperature or a degree of wear of an individual component of a dosing valve, for example a degree of wear of an ejection element.

Further status values may be a number of shot cycles, (sensor) signals from a droplet detector, in particular a missing droplet break-off, signals from flow sensors in the feed channel, in particular a throughput which deviates from a nominal value, signals from fill level sensors of a dosing material cartridge, passage of a defined period of time, in particular as regards a processing time for a dosing material, or reaching a regular maintenance interval for a component.

A status value can also be determined in a manner such that a dosing precision can be established for a specific dosing valve. Preferably, a status value may be a quantity of dosing material which is delivered from a dosing valve during a respective ejection procedure, and/or a shape of a delivered droplet of dosing material.

Preferably, measurement values which represent the respective status value are fed to the control device. Preferably, as a function of at least one status value, in particular a measurement value, an exchange process can be initiated by the control device. As an example, the operating control unit can generate a control signal as a function of at least one status value and/or can send it to the unit control unit in order to dispose a specific dosing valve in an exchange position.

The measurement values can be produced via sensors of the dosing valve and/or by means of a balance or a camera system as part of the dosing unit. Preferably, the control device can compare the respective status value during operation, preferably in real time, with an associated predetermined nominal value, wherein a remaining service time for a component can be determined thereby and/or a time for an exchange (exchange time) of a dosing valve can be (pre)determined.

As an example, the control device can carry out an automated exchange of a dosing valve as soon as a specific status value of the dosing valve reaches and/or exceeds a maximum permissible value and/or deviates from an associated nominal value by a specific value. Optionally, an exchange notification or wear notification could be generated by the control device beforehand and might have to be confirmed by a user.

Preferably, the control device can be configured such that, in particular insofar as the dosing unit comprises a number of dosing valves and/or dosing devices, a sequence plan is generated for the automated exchange process. Preferably, the control device, taking into consideration status values from different dosing valves, can plan the exchange process in the dosing unit such that the operation in the unit can be carried out without interruption, as far as possible. Preferably, the remaining service life of a component, the type of component to be exchanged, an exact exchange time, a location for an exchange, i.e. the spatial position of a dosing valve and/or a dosing device in the unit, can be taken into account in the sequence plan.

As an alternative or in addition, the control device can also be programmed such that a specific dosing valve is routinely or regularly changed. An appropriate status value can, for example, be a maximum service time for an ejection element or a maximum permissible number of expansion cycles for a piezo actuator or a specific number of shot cycles. In principle, it is also possible for manual intervention in the automated exchange process to occur, for example when (exceptionally) a specific dosing valve has to be exchanged independently of reaching a status value, i.e. the exchange process can also be initiated by a manual (user) input.

For the sake of completeness, it should be pointed out that in a dosing unit which is configured for an automated exchange process, it is also possible for a coupling and/or uncoupling of a dosing valve to be carried out (entirely) manually by a user, in particular with the formation of an interface between the dosing valve and a dosing device and/or a supply device.

Preferably, the superordinated control device is configured to carry out all process steps of the method in accordance with the invention for automated coupling and/or uncoupling independently and/or to apply corresponding control signals to the assemblies involved for carrying out the method, in particular taking into account the previously generated sequence plan.

Preferably, the individual dosing systems and/or the individual dosing devices respectively have their own, separate (local) control unit, in particular in the form of partial control units. In particular, a respective dosing valve can be associated with its own partial control unit in order to form a dosing system in this way. As an example, a (local) partial control unit can be disposed in a respective actuator unit of a dosing valve. Preferably, the partial control units are configured at least to locally control the dosing operation of a respective dosing valve. As an example, cooling and/or heating devices of the dosing valve could be controlled by means of a partial control unit, for example in order to set a specific temperature in the dosing material, and/or a clock frequency for the dosing material delivery could be controlled.

Preferably, the respective partial control units of the dosing valves or dosing systems can communicate with other partial control units of a dosing unit, in particular also with an operating control unit and/or a unit control unit. In particular, the partial control units of the dosing valves can form part of a superordinated control device. In other words, the respective partial control units can be configured as sub-components of the superordinated control device.

In principle, it would be possible, in particular insofar as a dosing unit has only a single dosing system, for a control device of the dosing unit to be realized as a part of a specific dosing system. As an example, a (local) control unit of a dosing system could in principle also be configured to control both the dosing operation of the dosing system as well as the method for an automated exchange. Furthermore, it is in principle possible for at least some dosing valves of a dosing unit to have no separately configured partial control unit of its own, but only to be controlled from a superordinated control device.

However, in the context of the invention, it is preferable for a respective dosing valve to be associated with its own partial control unit, wherein the dosing valve can also be controlled from a superordinated control device. Preferably, the superordinated control device can then control at least the functions of the dosing valve, which are involved in a coupling and/or uncoupling process for the dosing valve. This means that a dosing system is preferably configured thereby such that during operation a, for example external, superordinated control device of the dosing unit is associated with a respective dosing valve, wherein the dosing valve additionally has an (internal) separate partial control unit, in particular for controlling the dosing operation, and wherein a dosing material reservoir is associated with the dosing valve. The invention will be described in a non-limiting manner, with the aid of a dosing valve of this type with a local partial control unit, which is realized as part of the superordinated control device, wherein the superordinated control device, at least via the partial control unit, is also configured to control and/or regulate the dosing operation of the respective dosing valve separately.

In the context of the invention, a dosing unit can comprise two of more dosing devices. For the purposes of comprehension, the invention will now—unless stated otherwise and in a non-limiting manner—be described purely by way of example with the aid of a single dosing device with only one dosing system or one dosing valve. The advantageous further embodiments of the invention are applicable to a plurality of dosing devices and/or dosing valves in an identical manner. Accordingly, the components of the exchange system may be present more than once.

A dosing unit can preferably have at least one exchange system with at least one magazine or an (intermediate) store for storing at least one dosing valve. Preferably, a respective magazine can be configured such that two or more dosing valves can be stored simultaneously. Such a magazine can, for example, be in the form of a storage station.

In its simplest form, a magazine or an exchange magazine can be a static, for example linear, magazine with at least one storage location, preferably with two or more separate storage locations, for a respective dosing valve. Such a static magazine has the advantage that it is comparatively inexpensive and lends itself to the case in which only a few dosing valves have to be stored at the same time.

Preferably, however, a magazine can be configured such that at least one dosing valve can be movably stored in the magazine. As an example, a magazine can be in the form of a carousel (carousel magazine) wherein, for example, during operation, a horizontally rotatable wheel has a number of storage locations. As an alternative or in addition, a magazine can be in the form of an “open track” with at least one movable chain, wherein the movable chain has a plurality of storage locations for a respective dosing valve. A movable storage in the magazine could, for example, also be produced by means of a controllable conveyor belt in the magazine.

Irrespectively of the specific embodiment, the magazine of the exchange system is preferably configured so that it can store at least two different embodiments and/or configurations of dosing valves, in particular at the same time. Accordingly, at least two storage locations or receiving points in the magazine can be configured differently so that different embodiments of dosing valves can be mounted in it. As an example, the magazine can be configured to accommodate at least one jet valve, a contact dosing valve and/or a needle dosing valve.

In principle, a magazine of a dosing unit can be configured to receive at least one dosing valve and at least one other tool, preferably simultaneously. Such a tool can, for example, be a UV lamp for curing adhesives or a grab for moving/placing components.

In order to store a dosing valve in the magazine, the magazine can comprise a latching element and/or a, preferably controllable, locking mechanism. The locking mechanism is preferably configured to retain the dosing valves stored in the magazine during an intended movement of the magazine, for example when the magazine is moved in the dosing unit. Preferably, each storage location in the magazine is associated with a sub-locking mechanism which is to be separately operated. As an example, locking of a respective dosing valve in the magazine can be carried out by means of a separate snap-fitting mechanism. As an alternative or in addition, locking can also be carried out by means of an interlocking connection. As an example, a specific dosing valve can be placed on a mating piece which is complementary in form at a storage location. Furthermore, it is also possible to suspend a dosing valve in a storage location, whereupon the dosing valve is then held under its own weight.

Irrespectively of the specific embodiment, a magazine can be disposed in the dosing unit in a stationary manner. As an example, a stationary magazine can be disposed in a maintenance region of the dosing unit, in particular spatially separated from a dosing valve and/or from a dosing device. In this case, it is preferable for the dosing device to be movable at least in part in order to bring a dosing valve on the dosing device into a specific exchange position, in particular via a command from the superordinated control device.

Preferably, the dosing device is configured so as to be at least partially movable, in particular with respect to the magazine, and therefore to be controllable in a manner such that, in the automated process, a dosing valve in the magazine is brought into operative contact with the dosing device for coupling with the dosing device. In particular, the dosing valve can be coupled as a consequence of the operative contact. Preferably, the dosing device can be moved in a manner such that a mating interface portion of the dosing device comes into operative contact with the valve interface portion of the dosing valve to be coupled.

Preferably, the dosing device can be controllable from the control device and configured in a manner such that in the automated process, a specific dosing valve from the magazine is brought into operative contact with the dosing device in order to couple the dosing valve and/or in a manner such that, in the automated process, a specific dosing valve coupled with the dosing device is deposited in the magazine, preferably at a specific position. In particular, a specific (free) mating interface portion of the dosing device can be brought into operative contact with a specific dosing valve in the magazine. This means that at least one element of the dosing device, preferably the entire dosing device, can be controlled in a manner such that a specific coupling point (as the mating interface portion) is moved towards the magazine for coupling of the dosing valve.

The dosing device can, for example, comprise a movable robotic system or another positioning system, for example a three-axis positioning system. Preferably, at least one movable part of the dosing device is configured in order to be able to approach or drive up to a specific position in a magazine.

As an alternative or in addition, the magazine can be movably configured with respect to the dosing device and be controllable by the control device in a manner such that, in the automated process for coupling the dosing valve, preferably, a specific dosing valve in the magazine is brought into operative contact with the dosing device, in particular leading to coupling. Preferably, the magazine can be movable in configuration such that a valve interface portion of a specific dosing valve in the magazine is brought into operative contact with a specific mating interface portion of the dosing device.

Furthermore, the magazine can be movable in configuration and controllable in a manner such that, in the automated process, a specific dosing valve coupled with the dosing device is deposited in the magazine, preferably at a specific position.

In this case, then, the magazine is moved spatially with respect to the dosing device. A movable magazine can preferably comprise a robotic system which can be controlled and moved in the dosing unit. Particularly advantageously, a movable magazine in combination with a static (stationary in the dosing unit) dosing valve or a “static manipulator” can be employed. This is the case, for example, with dosing valves from dosing devices which dispense onto a belt conveyor. In principle, a combination of the aforementioned embodiments would also be possible. As an example, a dosing valve can be brought into a specific exchange position by means of an at least partially movable dosing device, wherein a movable magazine is moved into the same exchange position for the exchange process.

Particularly preferably, the exchange system can have at least one, preferably two or more movable exchange devices which are respectively configured and controllable by the superordinated control device in a manner such that, in the automated process, a transfer of at least one dosing valve can be carried out between the magazine and the dosing device by means of a respective exchange device.

In particular, the respective movable exchange device can be configured so as to be capable of being controlled such that, in the automated process, a dosing valve from the magazine is brought into operative contact with the dosing device for coupling via the exchange device and/or such that a dosing valve from the dosing device, preferably a dosing valve to be uncoupled, is transferred into the magazine.

In accordance with one embodiment, the movable exchange device preferably constitutes a separate intermediate system which in particular is freely movable in the dosing unit, and can transport at least one dosing valve from the magazine to the dosing device and vice versa. A movable exchange device of this type is described as an “exchange manipulator”.

Preferably, a mating interface portion with a transport coupling element for forming a transport coupling can be associated with the exchange manipulator (as part of the exchange system), wherein the valve interface portion can have a complementary transport coupling element. Preferably, in the automated process, the valve interface portion and/or the mating interface portion is configured in order to detachably couple the dosing valve, via an interaction between the valve interface portion and the mating interface portion, with the exchange system, preferably with the exchange manipulator, for a transportation of the dosing valve in the dosing unit.

The exchange manipulator can be configured to form a respective transport coupling with two or more dosing valves. Accordingly, the exchange manipulator can have two or more separately controllable transport coupling elements.

A transport coupling can be based on an electrical and/or pneumatic and/or hydraulic connection of the coupling portions or the transport coupling elements. In principle, a mechanical connection of the coupling portions is also possible. Preferably, the transport coupling, in particular the opening and closing of the coupling, can be controlled from the superordinated control device.

The respective transport coupling elements are preferably configured to produce, via the transport coupling, at least one, preferably a plurality of electrical and/or mechanical and/or signalling and/or pneumatic and/or fluid-conducting connections between the exchange manipulator and dosing valve, in particular between the dosing valve and a supply device co-operating with the exchange manipulator. Accordingly, the transport coupling can be configured to detachably couple the dosing valve with an associated supply device, in particular during a transportation of the dosing valve in the dosing unit. Advantageously, the dosing valve can also be supplied, for example with electricity or with compressed air, during a transportation inside the dosing unit, wherein the dosing valve is kept in a standby mode, for example. Accordingly, after coupling with the dosing device, the dosing valve can start operating without preparatory measures. More advantageously, a leakage of dosing material during the transport can be avoided via the transport coupling.

The respective exchange manipulator can comprise at least one controllable robot, in particular an industrial robot. Preferably, the exchange manipulator can comprise a controllable robotic arm which can move freely in the dosing unit and has at least one mating interface portion disposed thereon, preferably in combination with a base which can move freely in the dosing unit, for example a mobile base. Advantageously, the radius of movement in the dosing unit can be expanded and can be individualised.

As an alternative or in addition, an exchange manipulator can also be produced by means of a transport device, which can be firmly installed in the dosing unit. As an example, the transport device can have a guide system, wherein at least one mating interface portion of the exchange system is movable along at least one guide plane of the guide system, in particular in a linear movement. Preferably, the guide system can also have two or more guide planes or guide axes, wherein the guide system can in particular be configured as a two-axis or three-axis robot (XYZ system). In principle, the dosing unit may have two or more, preferably different, exchange manipulators.

In accordance with one embodiment, a movable exchange device of the exchange system can be configured and controllable from the control device in a manner such that at least one dosing valve is detachably coupled with the exchange device for the purposes of delivering dosing material. Preferably, the movable exchange device, in particular a work manipulator, can be configured such that a dosing valve is also coupled with the movable exchange device for or during a delivery of dosing material. Preferably, the respective work manipulator, distinct from an exchange manipulator, can be configured such that an operative connection can be produced between a coupled dosing valve and a dosing device and/or a supply device for intended delivery of dosing material. Advantageously, during operation, the dosing valve can be brought to a specific dosing point by means of the robotic arm and/or held there and/or can be brought between different dosing points.

Preferably, the work manipulator is configured so as to be controllable such that in the automated process, a dosing valve from the magazine is brought into operative contact with the dosing device for coupling via the work manipulator, wherein the operative contact is produced by the work manipulator itself. Accordingly, the work manipulator can be configured and can be controlled such that a dosing valve to be uncoupled from the dosing device can be transferred into or deposited in the magazine by the work manipulator.

In accordance with this embodiment, the work manipulator, in particular the mating interface portion, can itself carry out a movement for coupling and/or uncoupling a dosing valve. Preferably, a coupled dosing valve can be moved by the work manipulator between a working position or a dosing point and an exchange position and/or a magazine.

Advantageously, by means of a movable exchange device, a spatial distance between the magazine or an exchange position and a specific working position of a dosing valve can be covered. On the one hand, this has the advantage that the magazine and/or the dosing device can be configured (static) so as to be stationary with respect to each other or stationary inside the dosing unit, which makes the assemblies cheaper. More advantageously, in the case of a stationary dosing device with a plurality of dosing valves, an exchange can also be carried out during operation of the dosing device, i.e. while the remaining dosing valves are active. In contrast to a manual exchange of components, in the case of the controllable exchange manipulator, shutting off the dosing device for safety reasons is not necessary. More advantageously, after the exchange of a dosing valve, an exchange manipulator can be completely removed again from the working region of the dosing device so that the working region is not permanently restricted.

It should be noted that an exchange system can also have a combination of at least one work manipulator and at least one exchange manipulator. By way of example, for an exchange process for a dosing valve, the exchange manipulator can be brought into an exchange position, wherein the work manipulator brings a dosing valve to be exchanged from a working position into the same exchange position and wherein the work manipulator transfers the dosing valve to the exchange manipulator. Furthermore, a movable exchange device can in principle also be used in combination with a movable magazine and/or with an at least partially movable dosing device, wherein the respective components can preferably move to the same exchange position for an exchange process.

Advantageously, irrespectively of the specific embodiment, the exchange system and/or the dosing device can be configured and be controllable by the control device in a manner such that a specific dosing valve from a magazine can be brought into operative contact with the dosing device, in particular with a specific coupling point as a mating interface portion on the dosing device or with a mating interface portion of a work manipulator, for coupling the dosing valve. A “specific” dosing valve can be characterized in that by means of this dosing valve, a specific dosing pattern can be obtained. As an example, a specific dosing valve can have a special nozzle shape and/or a particular ejection element in order to obtain a required configuration of a dosing system during operation. Furthermore, the exchange system and/or the dosing device, in particular the exchange manipulator and/or a work manipulator, can be configured so as to be capable of being controlled such that an uncoupled dosing valve can be deposited at a specific, i.e. defined, position in the magazine.

In order to selectively directly or indirectly couple a dosing valve from the magazine with the dosing device, the magazine can preferably comprise an internal (of the magazine) moving mechanism, in order to bring a specific dosing valve and/or in order to bring a specific (free) storage location into a defined position, in particular into a transfer position. Preferably, in the transfer position, a coupling and/or an uncoupling of the dosing valve can be carried out, in particular in the case of a locally movable magazine.

As an alternative or in addition, the exchange manipulator and/or the work manipulator can be configured so as to be controllable so that a specific dosing valve can be selectively taken from the magazine. Preferably, the exchange manipulator and/or the work manipulator, for example as part of the mating interface portion, can have an integrated tool identifier in order to identify different dosing valves. Preferably. the exchange manipulator and/or the work manipulator can have an identification means for contactless identification and/or assignment of a specific dosing valve. Preferably, the identification is carried out via a RFID system (Radio Frequency Identification). Preferably, the exchange manipulator and/or the work manipulator, in particular the mating interface portion, can comprise at least one RFID reader in order to identify a characterizing code of a specific dosing valve. Accordingly, a RFID transponder can be associated with a respective dosing valve, or it can have one. Advantageously, via the integrated tool identification, a dosing valve with a specific configuration can be identified and/or selected by the exchange manipulator or work manipulator.

As an alternative or in addition, the respective dosing valves can, for example, be characterized via a machine-readable code, such as a barcode, which can be detected by the exchange manipulator and/or the work manipulator. It would also be possible for the exchange manipulator and/or the work manipulator to have a positioning system and preferably can move to a predetermined position in the dosing unit by means of the control by the control device, in particular a specific position in the magazine.

Advantageously, by means of an exchange system which can be controlled in this manner, a respective magazine can store a large number of dosing valves simultaneously, so that fewer magazines are required in the dosing unit, wherein nevertheless, a selective coupling of a specific dosing valve is guaranteed. More advantageously, the exchange system, in particular the magazine, can have at least one closing element, in order to close a nozzle opening of a dosing valve from outside, in particular during an exchange procedure and/or during storage in the magazine. Preferably, the exchange system, in particular the magazine, can have a plurality of separately controllable closing elements, in order to close a respective associated nozzle opening while being held in the exchange system. Advantageously, this means that even in the case of dosing valves with a “normally open” position, a leakage of dosing material is prevented.

Particular advantages arise with a combination of a movable exchange manipulator and/or a work manipulator with a magazine with internal moving mechanism. The magazine can be controlled in a manner such that a free storage location is disposed in a transfer position and can then cooperate with the exchange manipulator or the work manipulator such that an “old”, i.e. uncoupled dosing valve or a dosing valve which is to be uncoupled, can be received. After transfer is complete, a “new” dosing valve, i.e. a dosing valve which is to be coupled, can be provided in the same transfer position via the internal moving mechanism and can be received by the exchange manipulator or the work manipulator without the exchange manipulator or the work manipulator itself having to be moved. This means that the exchange process is speeded up. Preferably, the components involved for the exchange process can be brought into the same exchange position.

In principle, it would also be possible to combine the previously described embodiments. This means that a dosing unit can comprise at least one stationary magazine and/or at least one spatially movable magazine, each with or without internal moving mechanism, and/or at least one dosing device which can be moved at least in parts and/or at least one static dosing device and/or at least one movable exchange manipulator and/or at least one work manipulator, which can respectively interact with each other for an automated dosing valve exchange.

Irrespectively of the specific embodiment, the magazine of the exchange system can have at least one maintenance coupling element which is configured to cooperate with an associated coupling element of the dosing valve, preferably at least one supply coupling element of the valve interface portion, in order to form a maintenance coupling. The maintenance coupling element is preferably formed by a mating interface element of the mating interface portion.

The maintenance coupling is preferably configured to detachably connect at least one supply line of the dosing valve, in particular during a storage in the magazine, with the supply device, in particular with a maintenance device. The maintenance device can be part of the supply device and is preferably separately controllable. In this configuration, the mating interface element is associated with the supply device, wherein the mating interface element is provided by the magazine. In this embodiment, in the automated process, the dosing valve can be detachably coupled (only) with the supply device by the exchange system via the maintenance coupling element in the magazine. Accordingly, the dosing valve can then not be coupled with the dosing device. Preferably, the supply device of the dosing unit can comprise a separately constructed and controllable maintenance device which supplies the maintenance coupling.

The maintenance coupling element is preferably configured, during the storage of the dosing valve in the magazine, to make at least one, preferably a plurality of, electrical and/or mechanical and/or signalling and/or pneumatic and/or fluidic, in particular medium-conducting, connections between the maintenance coupling element and the valve interface portion via the maintenance coupling. Preferably, a separately controllable maintenance coupling element can be associated with each storage location for a dosing valve in the magazine.

Preferably, the respective maintenance coupling is configured to introduce a cleaner into the dosing valve for cleaning. As an alternative or in addition, the maintenance coupling can be configured such that in this manner, a heating device of the dosing valve can be controlled and/or a memory of the dosing valve can be read. Preferably, the dosing valve can be controlled by the control device via the maintenance coupling. In accordance with one embodiment, a maintenance coupling can also comprise a function coupling, for example for retaining the dosing valve in the magazine.

Advantageously, via the maintenance coupling, data from an internal EEPROM can be read and fed to the control device, for example the following parameters: serial number, shot count, configuration of the dosing valve, dosing medium or dosing material and other data. In this way, a configuration and/or a status of a respective dosing valve can be optically displayed to an operator of the dosing unit, for example as to whether a dosing valve is capable of functioning, when or whether a maintenance is necessary, a fill level of a dosing material cartridge, etc. Furthermore, the information read out can be processed by means of the control device in a manner such that during a pending exchange, a specific “suitable” dosing valve can be selected for the automated exchange. More advantageously, via the maintenance coupling, a (pre)cleaning of the dosing valve, in particular the fluidic unit, can be carried out during storage in the magazine or in the storage station, so that hardening of the material in the fluidic unit is avoided and any possible later maintenance or any further cleaning is facilitated.

More advantageously, by means of the control of the heating device in the magazine, a nozzle, for example, and/or the entire fluidic unit and/or the dosing material in the fluidic unit can be preheated to a specific (operating) temperature, in particular before a pending exchange of the dosing valve. Advantageously, a preset temperature can be set in the dosing valve, so that a dosing process can be carried on directly after an exchange, for example by holding the dosing valve in the magazine in a standby mode.

Particularly advantageously, a calibration of the dosing valve and/or an adjustment of the dosing valve can be carried out via the maintenance coupling, in particular by means of the control device. Advantageously, an actuator can be adjusted via the maintenance coupling.

Furthermore, the dosing valve in the magazine can be supplied with electricity and/or with compressed air via the maintenance coupling.

In order to construct the maintenance coupling, a respective maintenance coupling element in the magazine is preferably configured so as to be complementary with the valve interface portion, preferably with a supply coupling element and/or with a function coupling element, in particular in order to configure a maintenance coupling in the automated process.

The supply coupling element of the dosing valve can advantageously be formed by a valve interface element and is (also) configured to form a supply coupling with a mating interface portion in dosing operation, the mating interface portion preferably being associated with the dosing device, in particular comprising a supply device.

Preferably, the mating interface portion which is associated with the dosing device can have a mating interface element, wherein at least one supply coupling element which is complementary to the supply coupling element of the dosing valve is formed thereby. Preferably, in the automated process, the supply coupling element of the valve interface portion can be brought into operative contact with the supply coupling element which is associated with the dosing device, with the formation of an interface, wherein the supply coupling is formed thereby. The supply coupling element can be disposed on the dosing device itself and/or can be provided by a work manipulator.

The supply coupling is preferably configured so that during operation of the dosing valve, at least one, preferably a plurality of supply lines of the dosing valve are coupled with the supply device, preferably with the dosing device. A supply line of the dosing valve can be one of the following (operating) lines: a line for supplying dosing material pressure, a line for feeding (pressurised) dosing material, a line for controlling a heating device and/or a cooling device for the dosing valve, a line for feeding cooling medium into the dosing valve, a line for controlling the actuator, for example for supplying compressed air, a line for data transfer, in particular for control signals to control an actuator and/or for measurement values from sensors of the dosing valve.

Preferably, the supply device can be configured as part of the dosing device and is preferably capable of being controlled so that during operation, a plurality of dosing valves can be controlled separately via the respective supply couplings. In this embodiment, the dosing valve can simultaneously be coupled, via the mating interface portion associated with the dosing device, with the dosing device and with the supply device. Irrespectively of the specific embodiment, the supply device can be configured to at least supply a coupled dosing valve with a pressurised medium for an actuator and/or a pressurised medium for a dosing material and/or a pressurised dosing material and/or a coolant, in particular pre-cooled, in a controlled and/or regulated manner, wherein the dosing valve can also be supplied with electrical energy via the supply device.

Preferably, a respective supply coupling element of a dosing valve can be configured so that two or more separate supply lines of the dosing valve can be functionally coupled with a respective associated line in the mating interface portion. The supply coupling element of the dosing valve is preferably configured so that during operation of the dosing valve, at least one, preferably a plurality of electrical and/or mechanical and/or signalling and/or pneumatic and/or fluidic, in particular medium-conducting, connections are produced between the valve interface portion and the mating interface portion via the supply coupling.

The supply coupling element in the valve interface portion can comprise at least one sealing mechanism which is configured to close at least one supply line leading to the dosing valve, preferably to the fluidic unit, in a gas-tight and/or liquid-tight manner, in particular in the uncoupled state. Preferably, a respective fluid-conducting line in the valve interface portion is configured so as to be self-sealing, so that a leakage of medium from the line is prevented when the interface is open. In similar manner, the interface element of the mating interface portion can have a closing mechanism. As an example, a supply coupling element of the valve interface portion and/or of the mating interface portion can be configured as a “self-sealing coupling” or as a closure coupling.

Preferably, a signalling connection between the dosing valve and the superordinated control device can be formed via the supply coupling. Preferably, control and/or regulation signals can be supplied from the control device to the dosing valve via the supply coupling, wherein sensor signals or measurement values can be fed from the dosing valve to the control device. Preferably, the superordinated control device can be formed as part of the dosing device, wherein the dosing valve can then be coupled with the supply device and with the control device (respectively as part of the dosing device) via the mating interface portion associated with the dosing device, in particular via the supply coupling element.

Preferably, the valve interface portion of the dosing valve has a further valve interface element, whereupon a (first) function coupling element is formed. Accordingly, the mating interface portion which cooperates with the valve interface portion, which is preferably associated with the dosing device, can have a further mating interface element, wherein thereby, a (second) complementary function coupling element is produced in order to form the function coupling. Depending on the embodiment, the second function coupling element can be disposed on the dosing device itself, or it can be provided by a work manipulator.

Preferably, the valve interface portion and/or the mating interface portion, in particular the respective function coupling elements, are configured in order to detachably couple the dosing valve with the associated coupling partner via an interaction between the valve interface portion and the mating interface portion, in particular in the automated process. As an example, the dosing valve can be disposed and/or retained on the dosing device with the formation of the function coupling for an intended dosing operation. Alternatively, the dosing valve can be retained on a work manipulator by the function coupling for the purposes of delivering dosing material and/or during a transportation.

The function coupling is preferably configured to produce a reversible connection, in particular substantially backlash-free, between the dosing valve and the dosing device or the work manipulator. Preferably, a respective connection is produced via the function coupling in a manner such that a (mounted) dosing valve can withstand accelerational forces of up to 10 g during operation.

The supply coupling and/or the function coupling are in particular configured so as to be controllable by a superordinated control device such that a coupling of the dosing valve with the supply device and/or with the dosing device occurs in the automated process via the respective coupling systems. As described, the coupling can be made directly or indirectly via a movable exchange device.

In principle, the function coupling and the supply coupling, in particular the respective interface elements, can be spatially separate from each other.

However, preferably, the function coupling element and/or the supply coupling element of the dosing valve merge into one another and/or form a combined or multifunctional coupling region. Accordingly, the mating interface portion can form a multifunctional coupling region. Preferably, a multifunctional coupling region can combine at least the functions of a function coupling element and a supply coupling element, preferably also the function of a coupling region for the exchange system. Preferably. a multifunctional coupling can be produced, with the formation of an interface via two cooperating multifunctional coupling regions, where one is associated with the dosing valve and the other is associated with the dosing device. The term “multifunctional coupling” or “combination coupling” should be understood to mean a coupling system produced from two coupling portions, wherein a function coupling and/or a supply coupling and/or a transport coupling can be formed via the multifunctional coupling (depending on the configuration or control).

Preferably, the multifunctional coupling can be configured as a coupling system for an automated exchange function. Preferably, such a multifunctional coupling can be produced in the form of a quick-change coupling. Advantageously, the coupling system can be based on an electrical and/or pneumatic and/or hydraulic connection of two coupling parts in order to form the coupling, in particular in order to form a function coupling. In principle, a mechanical connection of the coupling portions is also possible.

Advantageously, in a dosing valve with such a valve interface portion, a particularly rapid change of the dosing valve can be obtained, because all of the operating and supply lines of the dosing valve can be formed in a single automated coupling process, wherein at the same time, a secure attachment of the dosing valve to the dosing device or to the work manipulator is obtained. Advantageously, both dosing valves with an entrained (self-supporting) supply of dosing material as well as dosing valves which are continuously supplied with dosing medium via the supply device can be coupled via the valve interface portion. In both cases, the entire dosing valve can be detached from the dosing device or the work manipulator rapidly and without manual intervention, and can have maintenance carried out, for example outside the working region of the dosing device, so that there are no interruptions to the operation. In the case of a change in the configuration of a dosing valve, the time for equipping the unit can be substantially reduced. Because the mating interface portion which is associated with the dosing device is advantageously compatible with dosing valves which operate in different manners, the different types of dosing valves which are present in the dosing unit can be used in a versatile manner.

In accordance with one embodiment, the mating interface portion of the magazine, in particular the maintenance coupling element, can be configured such that a multifunctional coupling comprising a supply coupling and a function coupling can be formed with the dosing valve thereby in the automated process. Then, principally the mating interface portion, which is associated with the magazine, and the mating interface portion, which is associated with the dosing device, can be identical in configuration. As an alternative or in addition to a locking mechanism which might be present, the multifunctional coupling can be formed in the magazine.

For detachable coupling, the dosing valve can preferably comprise a connection mechanism with a first function coupling element and/or a second function coupling element, in particular respectively as part of a multifunctional coupling region. The first function coupling element is preferably part of the valve interface portion, wherein the second function coupling element can be part of the mating interface portion of the dosing device and/or the magazine and/or the exchange system. The connection mechanism will be described below—in a non-limiting manner—with the aid of a mating interface portion of a work manipulator, wherein the relevant features can also be produced in other mating interface portions.

Preferably, the connection mechanism can comprise a controllable electrical coupling mechanism and/or a pneumatic coupling mechanism and/or a hydraulic coupling mechanism and/or a mechanical coupling mechanism.

The connection mechanism can have at least one, preferably controllable, locking mechanism for detachably interlocking the two function coupling elements, in particular for inter-locking two multifunctional coupling regions or coupling portions. Preferably, the locking mechanism is configured as part of the mating interface portion of the dosing device and/or the magazine and/or the exchange system. As an example, the locking mechanism can be at least partially disposed on or in the work manipulator. The locking mechanism can be controlled by the control device during operation.

The locking mechanism can preferably comprise at least one movable actuator which can interact with an associated, for example complementary, latching element in the function coupling element of the dosing valve for interlocking. The actuator can be a pneumatic actuator, an electrical actuator, a magnetic actuator and/or a hydraulic actuator.

Advantageously, a particularly secure connection between the dosing valve and work manipulator can be obtained in the automated process via the controllable locking mechanism. Because the movable actuator is disposed in the mating interface portion, the weight of the dosing valve can be kept as low as possible. More advantageously, this also means that the number of actuators which are required in the dosing unit can be as low as possible.

Preferably, such a connection mechanism with a locking mechanism can be part of a multifunctional coupling. In accordance with one embodiment, such a connection mechanism can be part of a transport coupling.

Preferably, the function coupling element and/or the supply coupling element and/or the transport coupling element are configured and/or disposed so that the dosing valve can be simultaneously coupled via the function coupling element and/or via the supply coupling element and/or via the transport coupling element, in particular via all three elements, with a respectively associated coupling partner. In accordance with one embodiment, a multifunctional coupling can be formed via the function coupling element and the supply coupling element in dosing operation, preferably with a work manipulator. This can in particular be the case when the function coupling element also provides the coupling region of the dosing valve. In accordance with another embodiment, a multifunctional coupling can be formed by means of the function coupling element and the supply coupling element, for example with the mating interface portion of a dosing device, wherein at the same time a further multifunctional coupling can be produced via the transport coupling element, for example with an exchange manipulator.

Preferably, the respective coupling elements and therefore also the respective couplings can be controlled separately from the control device. As an example, depending on the operational state of a dosing valve, specific couplings can be formed or released again. In particular, the respective couplings are configured in order to form an interface between the dosing valve and an associated coupling partner. The term “interface” should be understood to mean a site or region at which the dosing valve interacts with an associated device, for example with another machine. Depending on the coupling state of the dosing valve, the interface can also comprise two or more, for example spatially separated, (interface) segments.

Advantageously, the exchange process for the dosing valve can be further optimised via such an interface. As an example, in order to uncouple the dosing valve, as an optional step of the method, prior to disconnecting the power and/or pressure of the (multifunctional) coupling between the dosing valve and the dosing device, a (multifunctional) coupling with the exchange manipulator can initially be formed, wherein the dosing valve is also coupled with the supply device thereby. Only after forming this interface segment can the coupling with the dosing device be opened in order to detach the dosing valve from the dosing device and transfer it into a magazine. In this manner, the dosing valve can be connected to a supply device during the entire exchange process essentially without interruption.

Preferably, the valve interface portion, in particular the function coupling element and/or the supply coupling element and/or the transport coupling element and/or the coupling region for the automated exchange via the exchange system, can respectively be configured as part of the dosing valve itself, in particular as an integral component of the dosing valve.

Advantageously, integrating at least one of the coupling elements into the dosing valve, the weight of the dosing valve is kept as low as possible. As an example, at least one coupling element can be formed by the dosing valve itself, for example by an actuator housing.

Accordingly, at least the mating interface portion associated with the exchange system could at least in part be formed by the exchange system, preferably the work manipulator and/or the exchange manipulator itself, in particular as an integral component. Alternatively, the mating interface portion can at least in part be disposed on the work manipulator and/or the exchange manipulator, for example attached to the outside thereof.

The dosing valve may have a transducer for a teach-in method for the exchange system, in particular for programming the work manipulator and/or the exchange manipulator. Preferably, the dosing valve can have a controllable laser as the transducer. Such a laser can be integrated into a respective dosing valve, or can be attachable. Preferably, a laser beam can be substantially parallel to an ejection direction of dosing material from the dosing valve or substantially parallel to a movement of the ejection element of the dosing valve. It would also be possible to provide a specific dosing valve in a dosing unit which is only configured for teach-in methods. As an example, a laser instead of a nozzle can be provided, especially at the same position, in such a dosing valve. Advantageously, with such a dosing valve which is configured for a teach-in method, the cost of programming the exchange system, in particular the work manipulator and/or the exchange manipulator, can be reduced by track acquisition. As an example, a specific dosing position on a substrate and/or a position of a dosing valve with respect to the exchange system can be learned thereby.

Preferably, at least one means for passive and/or active noise reduction can be associated with a dosing valve, in particular in order to reduce sound emissions during operation of the dosing valve. A passive noise reduction can, for example, be obtained by means of an insulation, wherein an active noise suppression can be obtained by means of anti-sound.

As an example, the (respective) dosing valve can be disposed in a housing with a valve interface portion, wherein the housing has a (passive) insulation and/or an active noise suppression.

In accordance with one embodiment, a mating interface portion can comprise at least one (further) interface element for detachable coupling and/or for the operation of a (another) tool, for example a UV lamp. Preferably, a multifunctional coupling region of the mating interface portion, in particular of a work manipulator, in addition to the described components for detachable coupling of a dosing valve, can have at least one separately controllable element which can cooperate with a complementary element of the tool, in order to supply the tool during operation. For the purposes of detachable coupling, the tool can be (functionally) coupled to the work manipulator via the function coupling element of the multifunctional coupling region. Advantageously, with this further embodiment, the work manipulator can on the one hand detachably couple a dosing valve for an intended dosing operation via the mating interface portion, wherein on the other hand, for example after the completion of a dosing job, that same work manipulator can couple another tool, for example for post-treatment of the previously dispensed dosing material.

The invention will now be explained again in more detail with reference to the accompanying figures and with the aid of exemplary embodiments. In this regard, in the various figures, identical components are provided with identical reference symbols. In general, the figures are not to scale. In the figures:

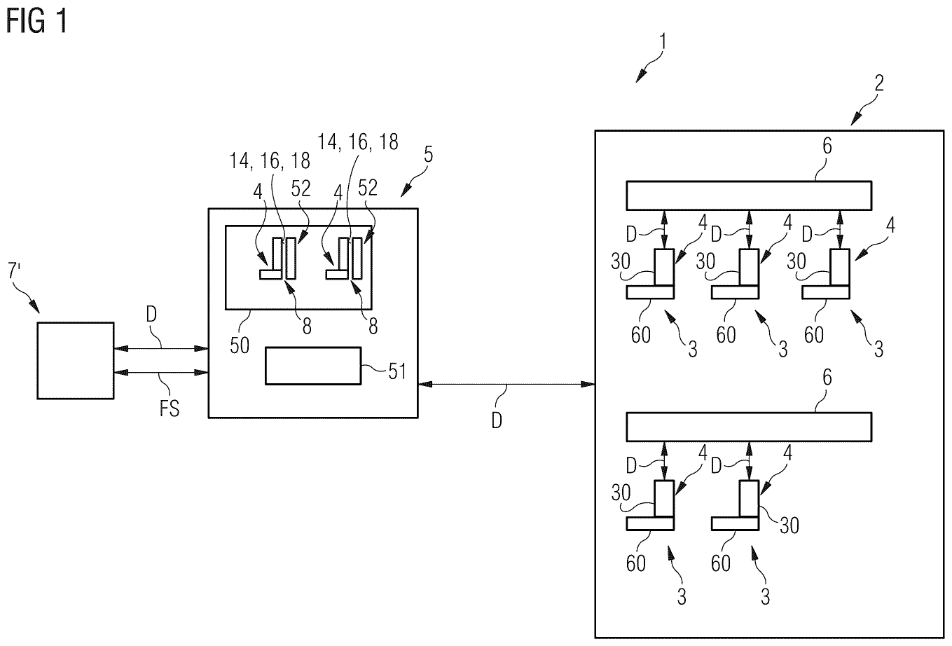

FIG. 1 shows a diagrammatic view of a dosing unit in accordance with the invention,

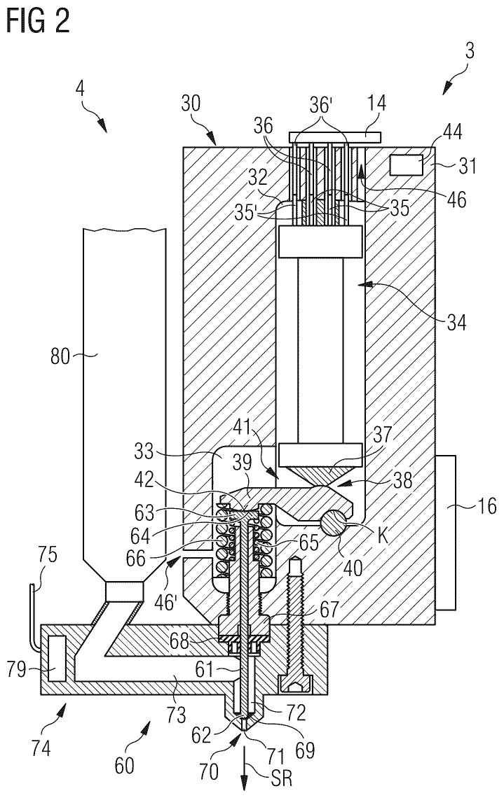

FIG. 2 shows a sectional view through parts of a dosing system in accordance with the invention,

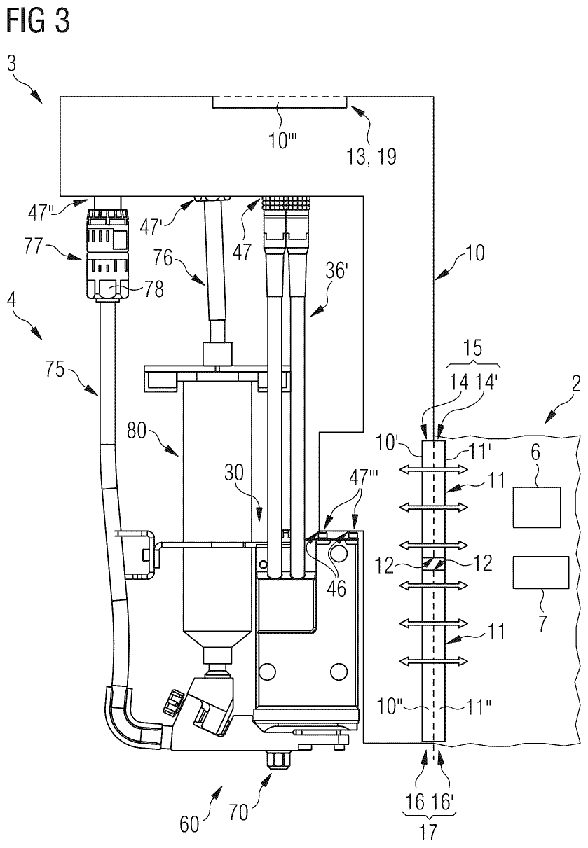

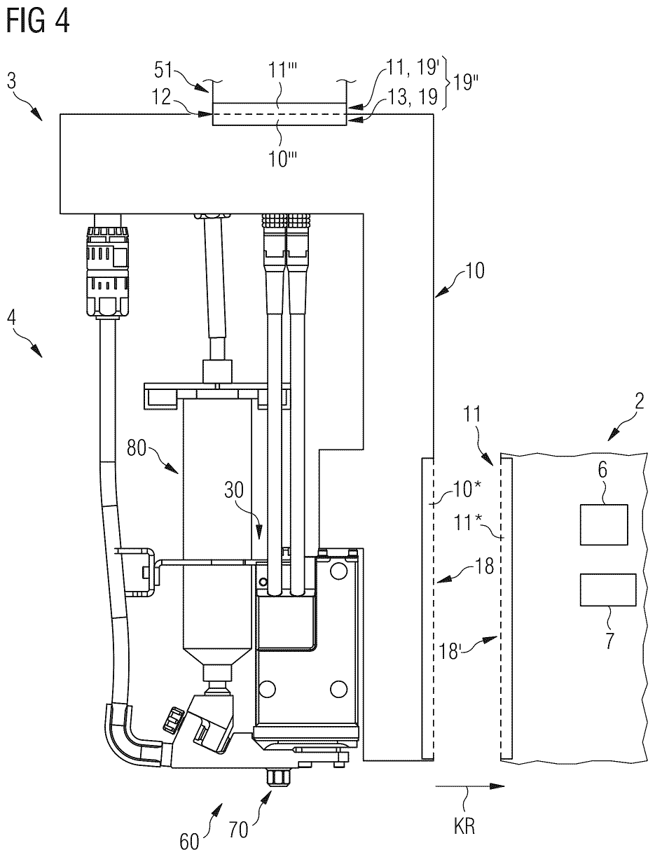

FIGS. 3 and 4 show diagrammatic views of dosing systems in accordance with the invention,

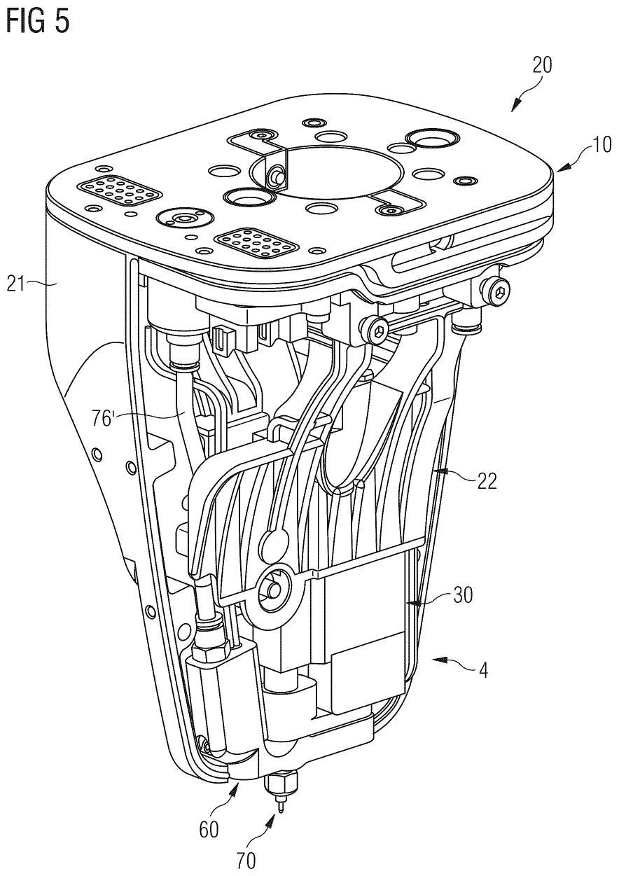

FIG. 5 shows a diagrammatic perspective view of a dosing valve with a valve interface portion in accordance with the invention,

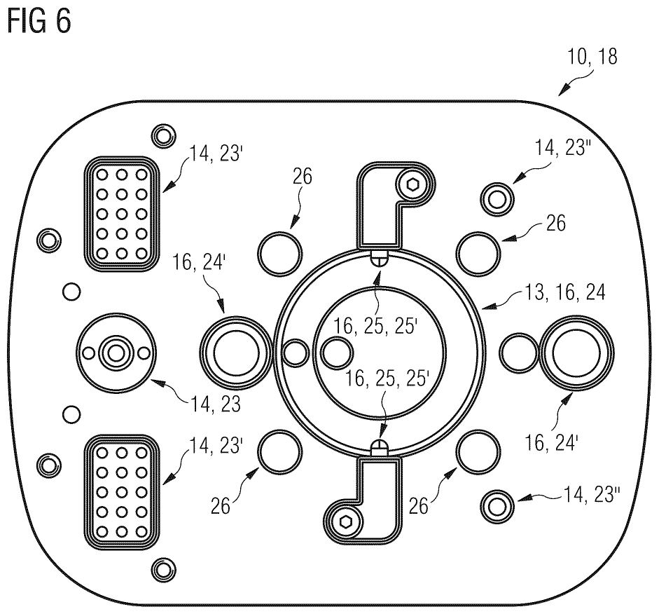

FIG. 6 shows a detailed view of the valve interface portion from FIG. 5,

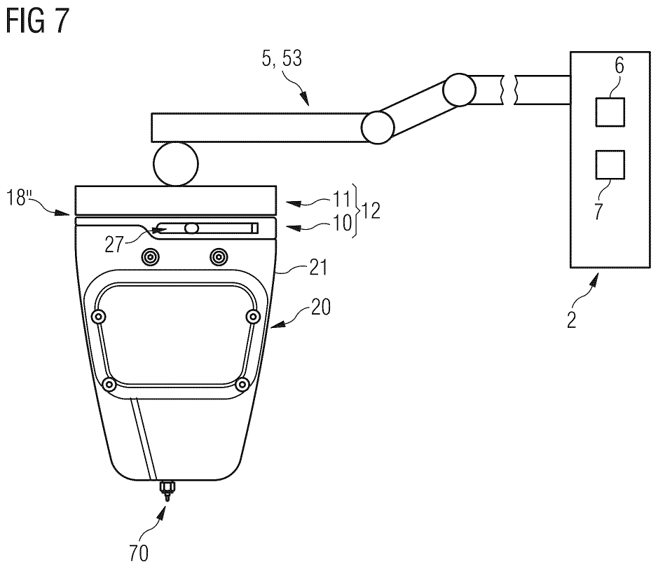

FIG. 7 shows a diagrammatic view of a dosing valve and an exchange system in accordance with the invention,

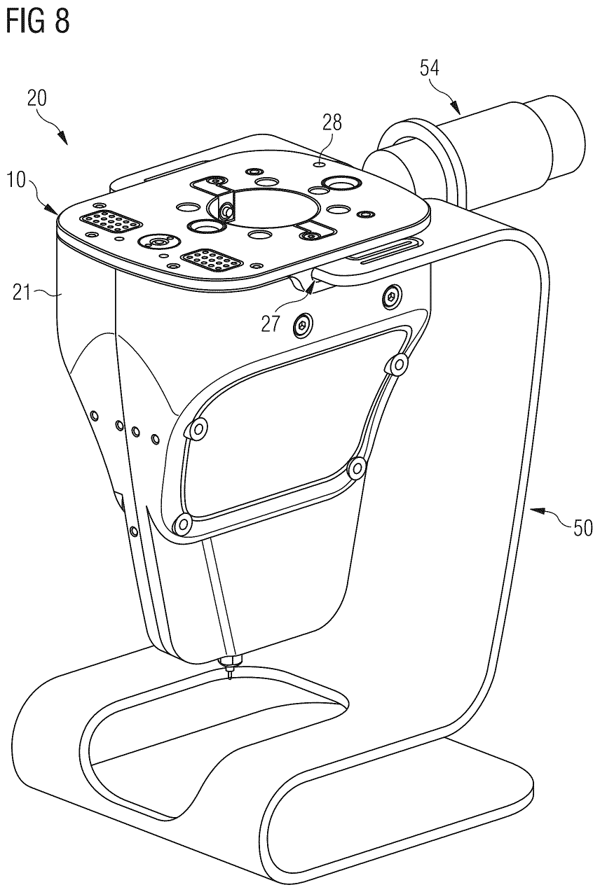

FIG. 8 shows a diagrammatic view of a dosing valve in accordance with the invention in a magazine.

An exemplary embodiment of a dosing unit 1 in accordance with the invention will be described with the aid of FIG. 1. The dosing unit 1 is shown purely diagrammatically and comprises, as essential components, a dosing device 2, which has a plurality of dosing systems 3, as well as an exchange system 5 and a maintenance device 7′. In a different manner to that shown here, the dosing unit 1 could form an entire production facility and can have two or more dosing devices 2. However, in principle, it is also possible for a dosing unit 1 to have only one dosing device 2 with only a single dosing system 3.

In FIG. 1, the dosing device 2 has five individual dosing systems 3, which are detachably disposed on the dosing device 2 in dosing operation. The individual dosing systems 3 here each have a fluidic unit 60 and a functionally cooperating actuator unit 30. The two components 30, 60 together form a respective dosing valve 4. The dosing valve 4 comprises all of the components which are actively involved in the delivery of dosing material and can also synonymously be termed a dosing head.

The individual dosing valves 4 here are, by way of example, respectively coupled with a superordinated decentralised control device 6 by circuitry or control means. Because the control device 6 here also has a regulation function, wherein appropriate electrical signals can be transmitted in both directions between the control device 6 and the dosing valves 4, a flow of data D or control data D is shown symbolically by double-headed arrows.

During operation, the superordinated control device 6 has several dosing valves 4 associated with it at the same time and can control its dosing operations separately. A respective dosing valve 4 and the associated control device 6 respectively form a dosing system 3 with a dosing material reservoir (not shown here) which, for example, can be formed by a supply device as part of the dosing device 2.

The control device 6 is shown in FIG. 1 as a superordinated external control device 6. The control device 6 is diagrammatically shown here with two partial control units, wherein the control device 6 can, for example, also be configured such that a plurality of partial control units are disposed at different positions inside the dosing unit 1 and cooperate in order to form the (overall) control device 6.

FIG. 1 shows an exchange system 5 with a magazine 50 and an exchange device 51 on the left, for example a movable exchange manipulator 51. The exchange manipulator 51 can, for example, be an industrial robot 51 which is movable in the dosing unit 1. The exchange system 5, in particular the magazine 50 and the exchange manipulator 51, are connected to the control device 6 for signalling purposes and can be controlled via appropriate data D and can also send data D to the control device 6.

Here, by way of example, the magazine 50 comprises two receiving positions each for a dosing valve 4. Each receiving position in the magazine 50 is associated with a maintenance coupling element 52. The dosing valves 4 are positioned in the magazine 50 so that a supply coupling element 14 and a function coupling element 16 of a respective dosing valve 4 cooperate with a respective maintenance coupling element 52 in order thereby to form a respective maintenance coupling 8. The supply coupling element 14 and the function coupling element 16 can preferably be formed as a multifunctional coupling region 18.

During the storage in the magazine 50, a signalling connection to the control device 6, for example, can be formed via the maintenance coupling 8. Furthermore, a specific dosing valve 4 in the magazine 50 can be supplied with a cleaning fluid via the maintenance coupling 8, shown here diagrammatically via a fluid flow FS between the maintenance device 7′ and the magazine 50. The maintenance device 7′ can be part of a supply device 7 (FIG. 3) and is formed separately here, wherein the maintenance device 7′ can have the same functions as the supply device. The maintenance device 7′ comprises a cleaning mechanism, not shown in further detail, wherein the maintenance device 7′ is connected for the purposes of signalling with the control device 6 and can exchange data D with it, for example in order to rinse a specific dosing valve 4 in the magazine 50 in accordance with a cleaning program. Furthermore, an adjustment of an actuator of a specific dosing valve 4 can also be carried out via the maintenance coupling 8.

FIG. 2 diagrammatically shows, in section, parts of a dosing system 3 with a jet valve 4 in accordance with the invention. Because the basic construction of jet valves is known, only the essential elements of it will be described below.

The dosing valve 4 has, as essential components, an actuator unit 30 and a fluidic unit 60. Furthermore, the dosing valve 4 here has a local control unit 44 and a dosing material cartridge 80 which is entrained during operation, wherein the dosing system 3 is formed thereby. During operation, the dosing system 3 is additionally connected to a superordinated control device (not shown here), which was described above with the aid of FIG. 1.

The actuator unit 30 essentially comprises all components which are used for driving or moving an ejection element 61 or a plunger 61 of the fluidic unit 60 in a nozzle 70. In addition to the nozzle 70 and a channel 73 for feeding dosing material to the nozzle 70, the fluidic unit 60 comprises all other parts which are directly in contact with the dosing material, as well as, in addition, the elements which are necessary for assembling the parts involved which are in contact with the dosing material together.

In the exemplary embodiment shown here, the actuator unit 30 comprises a housing block 31 with two inner chambers. An actuator 34 is disposed in an actuator chamber 32, in this case a piezo actuator 34, wherein here, the top of the actuator 34 bears on the inside of the actuator chamber 32. The dosing valve 4 here comprises a cooling device with a cooling medium feed 46 and a cooling medium discharge 46′, so that during operation, heat generated by the actuator 34 can be dissipated by means of a cooling medium flowing through the housing block 31 out of the actuator chamber 32 and out of the dosing valve 4.

Furthermore, the housing block 31 comprises an action chamber 33, into which a movable ejection element 61, here a plunger 61, of the fluidic unit 60 protrudes. By means of a lever 39 which protrudes into the action chamber 33 from the actuator chamber 32 via an aperture 41. the plunger 61 is actuated by means of the actuator 34 in a manner such that the dosing material to be dispensed is ejected from the fluidic unit 60 in the desired quantity at the desired time via the nozzle 70 in an ejection direction SR. The plunger 61 can close a nozzle opening 71 and therefore also acts as a closing element 61. Because, however, the major portion of the medium is firstly ejected out of the nozzle opening 71 by the plunger 61, when the plunger 61 moves onto the nozzle opening 71 in accordance with an ejection movement direction SR, it is designated here as an ejection element 61.

In order to control the piezo actuator 34, the actuator unit 30 can be connected electrically or for the purposes of signalling to a superordinated control device (not shown here). To this end, the actuator unit 30 has a supply coupling element 14, which here is disposed purely diagrammatically outside on the housing block 31. By cooperation with a complementary coupling element, not shown here, of a mating interface portion a function coupling can be formed via the supply coupling element 14, wherein in the case shown here, a plurality of electrical connections and a pneumatic connection can be formed, for example with a control device 6 and a supply device 7 (FIG. 3).

The supply coupling element 14 here contacts two piezo actuator control connections 36′ which each contact an electrical connector 35′ or a contact pin 35′ of the actuator 34, in order thereby to control the piezo actuator 34 during operation and/or to connect to the control device for signalling purposes. Furthermore, the supply coupling element 14 is in contact with temperature sensors, for example in the piezo actuator 34 (not shown) via temperature sensor connectors 36 and contact pins 35, wherein corresponding measurement values can be transmitted to the control device via the supply coupling element 14.

Furthermore, a pneumatic connection is provided via the supply coupling element 14, in order to supply the cooling medium feed 46 in the housing block 31 with a cooling medium, such as pre-cooled compressed air, or uncooled compressed air. Furthermore, via the supply coupling element 14, the local control unit 44 of the dosing valve 4 can also be connected to the superordinated control device for signalling purposes, wherein the superordinated control device and the local control unit 44 can interact. Other than shown here in a purely diagrammatic manner, the dosing material in the dosing material cartridge 80 could also be pressurised with a pressure medium via the supply coupling element 14.

Furthermore, a function coupling element 16, which is separate here, is disposed on the actuator unit 30, whereby a detachable coupling of the dosing valve 4 can be produced with a dosing device during operation, for example. This will be described with the aid of FIG. 3.

In FIG. 2, the piezo actuator 34 is programmed by the control device to stretch or expand and shrink again. The actuator 34 here is inserted into the actuator chamber 32 from above and mounted therein in a height-adjustable manner, wherein the actuator 34 is mounted downwards on the lever 39 via a pressure piece 37 which tapers to an acute angle at the bottom, which in turn sits on a lever bearing 40. The lever 39 can tilt about a tilt axis K via this lever mount 40, so that a lever arm of the lever 39 protrudes through the aperture 41 into the action chamber 33. At the end of the lever arm, it has a contact surface 42 which faces in the direction towards the plunger 61 of the fluidic unit 60 coupled with the actuator unit 30, the contact surface bearing on the contact surface 64 of the plunger head 63.

In the exemplary embodiment shown, the contact surface 42 of the lever 39 is permanently in contact with the contact surface 64 of the plunger head 63, because a plunger spring 65 pushes the plunger head 63 from below against the lever 39. In principle, it would also be possible, however, that in a starting or rest position of the plunger spring 65, there would be a gap between the plunger 61 and lever 39. In order to enable a near-constant preloading of the drive system, at the end which comes into contact with the plunger 61, the lever 39 is urged upwards by an actuator spring 66.

The plunger 61 is mounted by means of the plunger spring 65 on a plunger mount 67 which is closed downwardly by a plunger seal 68. The plunger spring 65 pushes the plunger head 63 upwards and away from the plunger mount 67 in the axial direction. Thus, a plunger tip 62 is also pushed away from a seal seat 69 of the nozzle 70. This means that without external pressure from above on the plunger head 63, in the rest state (non-expanded state) of the piezo actuator 34, a nozzle opening 71 is also not closed.

Feeding the dosing material to the nozzle 70 is carried out via a nozzle chamber 72 as well as a feed channel 73 connecting thereto, which is connected to the dosing material cartridge 80. The fluidic unit 60 comprises a frame part 74 with a heating device 79 which is connected to the control device via heating connector cables 75, and can additionally have yet more components. As a distinction from what is shown here, in the normal case, the heating connector cable 75 and the dosing material cartridge 80 can be coupled with the control device or the supply device via the supply coupling element 14, as will be described below with the aid of FIG. 3.

FIG. 3 shows a diagrammatic representation of a dosing system 3 with a dosing valve 4 in accordance with one embodiment of the invention. The dosing valve 4 comprises a fluidic unit 60 with a dosing material cartridge 80 which is entrained during operation. When in the dosing operation, the dosing material cartridge 80 is on the one hand coupled with the fluidic unit 60 and on the other hand via a supply line 76, here a medium pressure line 76, to a first interface portion 10 in the region of a connection point 47′. The first interface portion 10 or the valve interface portion 10 here comprises three separate and spatially separated valve interface elements 10′, 10″, 10″′, wherein a supply coupling element 14 (shown on the centre right), a function coupling element 16 (shown here on the bottom right) and a transport coupling element 19 (here at the top) are formed thereby.

The medium pressure line 76 is connected to the supply coupling element 14 via the connection point 47′, wherein the exact construction of the valve interface portion 10 is not shown in the diagrammatic representation of FIG. 3. Furthermore, the supply coupling element 14 is connected via a connection point 47″ to a heating control connector 77, which is in contact with the fluidic unit 60 via a heating connector cable 75. Here, the heating control connector 77 comprises a readable EEPROM 78. Furthermore, the supply coupling element 14 is connected to piezo actuator control connections 36′ in the region of a connection point 47 in order to supply the piezo actuator of the actuator unit 30 with control signals during operation. Furthermore, the supply coupling element 14 is connected to a cooling medium feed 46 via connection points 47″′ in order, during operation, to feed, for example, precooled cooling medium in a controlled and/or regulated manner.

In order to construct a supply coupling 15, the supply coupling element 14 of the dosing valve 4 is coupled with a complementary supply coupling element 14′ of a mating interface portion 11 to form an interface 12. wherein the mating interface portion 11 is associated with a dosing device 2. Here, the mating interface portion 11 is formed in multiple parts and here comprises an upper mating interface element 11′, whereupon the supply coupling element 14′ is formed, and here a lower, separate mating interface element 11″, whereupon a function coupling element 16′ is formed. The mating interface portion, in particular the two coupling elements 14′, 16′, are here, by way of example, disposed on the outside of the dosing device 2.

The dosing device 2 comprises a diagrammatically shown superordinated control device 6 and a supply device 7. During the operation of the dosing valve 4, the described electrical and pneumatic supply lines 36′, 46, 75, 76 of the dosing valve 4 and if necessary other operating lines of the dosing valve 4 are functionally connected to the control device 6 or the supply device 7 via the supply coupling 15, as shown here diagrammatically with double-headed arrows. In the embodiment shown here, the dosing valve 4 is disposed directly on the dosing device 2. An example of use of such a “static” dosing valve 4 is the dosing of dosing material onto a belt conveyor.

The valve interface portion 10 here comprises a separate valve interface element 10″, whereupon a function coupling element 16 is formed. The function coupling element 16 of the dosing valve 4 forms a function coupling 17 with the function coupling element 16′ in the mating interface portion 11. The dosing valve 4 for an intended delivery of dosing material in the case shown here is detachably disposed on the dosing device 2, or at least temporarily held thereon, via the function coupling 17. The detachable coupling via the function coupling 17 is diagrammatically shown here with double-headed arrows. The function coupling 17 forms a (further) part of the same interface 12, wherein the interface 12 is formed in multiple parts or comprises several interface segments.

In accordance with this embodiment, the valve interface portion 10 comprises a valve interface element 10″′, which is separate here, which forms a transport coupling element 19. The transport coupling element 19 can cooperate with a complementary coupling element in the mating interface portion 11 in order to form a transport coupling, as will be described with the aid of FIG. 4. The transport coupling element 19 here forms a coupling region 13 of the dosing valve 4 for an automated exchange of the dosing valve 4. In the state shown here, the dosing valve 4 is coupled with the dosing device 2 via the interface 12 for the dosing operation and therefore also coupled with the control device 6 and the supply device 7, so that the coupling region 13 or the transport coupling element 19 is temporarily free.

FIG. 4 shows a dosing valve 4 in an uncoupled state, for example shortly before an intended coupling with the dosing device 2. Because the construction of the dosing valve 4 mostly corresponds to that of FIG. 3, only the differences will be described below.

The valve interface portion 10 comprises a valve interface element 10″′, whereupon a transport coupling element 19 is formed. In the case shown here, the transport coupling element 19 forms a transport coupling 19″ with a complementary transport coupling element 19′ of the mating interface portion 11, wherein the mating interface portion 11 comprises a corresponding mating interface element 11″′. The interface 12 of the dosing valve 4 is formed here by the transport coupling 19″.

The transport coupling element 19′ of the mating interface portion 11 here is disposed on an exchange manipulator 51, for example on an industrial robot which is freely movable in the dosing unit. As an example, the mating interface element 11″′ can be attached to the outside of the exchange manipulator 51, for example screwed on. By means of the cooperation of the mating interface element 11″′ of the exchange manipulator 51 with the valve interface element 10″′ of the dosing valve 4, the dosing valve 4 can be detachably coupled with the exchange manipulator 51 for an automated exchange process.

The exchange manipulator 51, for example the industrial robot, is configured so as to be controllable, so that the dosing valve 4 can be moved towards the dosing device 2 in a coupling direction KR. The exchange manipulator 51 can move the dosing valve 4 so far in the direction KR until an intended coupling position is reached, wherein the valve interface element 10* and the mating interface element 11* of the dosing device 2 are in operative contact. As soon as the coupling position is reached, a multifunctional coupling can be closed by means of the control device 6, whereupon the dosing valve 4 is coupled with the dosing device 2 and thereby also with the control device 6 and the supply device 7.

In FIG. 4, the valve interface portion 10 (on the right), distinct from that in FIG. 3, comprises a contiguous valve interface element 10*, wherein a multi-function coupling element or a multifunctional coupling region 18 is formed. Accordingly, the mating interface portion 11 comprises only one contiguous mating interface element 11* with a multifunctional coupling region 18′. A multifunctional coupling between the dosing valve 4 and dosing device 2 can be formed via the two multifunctional coupling regions 18, 18′, whereupon the multi-functional coupling functions as a supply coupling and a function coupling. As soon as the dosing valve 4 is connected to the control device 6 and the supply device 7 (as part of the dosing device 2) via the multifunctional coupling, a complete dosing system 3 is formed.

FIG. 5 shows a diagrammatic view of a dosing valve 4 in accordance with a preferred embodiment of the invention, wherein the dosing valve itself is similar in construction to that described with the aid of FIG. 2. The dosing valve 4 here is surrounded by a housing 21 which is shown in part, wherein the housing 21 forms a valve interface portion 10. The valve interface portion 10 could also be disposed (externally) on the housing 21. In this embodiment, the dosing valve 4 with the housing 21 and the valve interface portion 10 formed by it form a coupling module 20 or a coupling unit.

The housing 21 here comprises two housing half-shells and can, for example, be produced from plastic or metal (for example aluminium, steel, stainless steel) or mixtures of different materials, wherein the housing 21 can reversibly be opened, for example for maintenance purposes. The dosing valve 4 is retained in the housing 21 via a valve retainer 22. For the purposes of supplying dosing material, the dosing valve 4 is connected to the valve interface portion 10 via a medium line 76′. Lastly, the connections between the valve interface portion 10 and the dosing valve 4 are not shown here in more detail. Advantageously, the dosing valve 4 can be protected from environmental influences by the housing 21, wherein the housing 21 can also be formed in order to reduce any noise developed by the dosing valve 4 during dosing operations, for example by means of an active noise suppression or insulation.

FIG. 6 shows the valve interface portion 10 from FIG. 5 in top view. In accordance with a preferred embodiment, the valve interface portion 10 is configured as an interface module. To this end, the valve interface portion 10 is in the form of a multifunctional coupling region 18 and comprises a plurality of components with different functions. In turn, the individual components can each form an interface and are designated as sub-interfaces or (interface) subunits. Preferably, the respective (interface) subunits can be separately controlled. The individual sub-interfaces can be connected at the back (not visible) with respective associated elements of the dosing valve (FIG. 5).

A first sub-interface 23 concerns a feed of dosing material to the dosing valve, wherein this sub-interface 23 can be connected at the rear side of the valve interface portion 10, not visible here, to a medium line 76′ (FIG. 5). The dosing valve can be electrically connected via a further, two-piece sub-interface 23′ or an electrical sub-interface 23′. A further, multi-part sub-interface 23″ is configured to supply the dosing valve with compressed air, for example for the purposes of cooling. As an example, compressed air can be introduced, here via the upper section of the sub-interface 23″, into the dosing valve and be fed back out again through the lower section here. In accordance with a preferred embodiment, the sub-interfaces 23, 23′, 23″ described above form a supply coupling element 14 as a component of a multifunctional coupling region 18.

Furthermore, the valve interface portion 10 comprises a sub-interface 24 for a mechanical coupling of the valve interface portion 10 with an associated mating interface portion. The sub-interface 24 here has a connection mechanism 25 with two locking lugs 25′ (as part of a locking mechanism 25′) for detachably interlocking two coupling halves. Distinct from what is shown here, the locking mechanism 25′ can, for example, comprise one or more controllable electrical or pneumatic actuators or control elements, which are preferably provided by a mating interface portion, for example by a robotic arm. Preferably, as part of the locking mechanism 25′, the valve interface portion 10 then has an appropriate number of complementary seats into which a respective actuator, for example a bolt, can engage (not shown). The valve interface portion 10 here additionally comprises a sub-interface 24′ in the form of centring holes in order to facilitate the coupling process. The sub-interfaces 24, 24′ described above with the connection mechanism 25 in this embodiment form a function coupling element 16 as part of the multifunctional coupling region 18. As shown here, the valve interface portion 10 can optionally have other sub-interfaces 26, for example for compressed air, for dosing material and the like.

In the preferred embodiment shown here, the coupling region 13 for the automated exchange of the dosing valve via the exchange system is formed by the function coupling element 16, here by the sub-interface 24. This means that on the one hand, the function coupling element 16 can be integrated into the automated exchange process, wherein it functions as the coupling region 13, and on the other hand it can form a function coupling in order to retain the dosing valve in dosing operation on a movable exchange device.

FIG. 7 diagrammatically shows a coupling module 20 which is coupled with a work manipulator 53 as part of an exchange system 5. The coupling module 20 can correspond to that from FIG. 5, for example. The coupling module 20 is connected to the work manipulator 53 via a multifunctional coupling 18″ permanently for the time period of the dosing operation by cooperation of the valve interface portion 10 with a mating interface portion 11 which is disposed on the work manipulator 53.

The work manipulator 53 is preferably a multi-axial jointed-arm robot 53, for example with 6 axes, wherein the mating interface portion 11 is rotatably mounted on the jointed-arm robot 53. The mating interface portion 11 comprises a drive for a locking mechanism (not shown), which can be mechanical, for example. As shown diagrammatically here, the mating interface portion 11 can, for example, be attached to the outside of the jointed-arm robot 53, for example screwed on. The jointed-arm robot 53 is connected to the dosing device 2, for example firmly, to a side opposite the mating interface portion 11. In the coupled state, via the interface 12, the dosing valve in the coupling module 20 can be (indirectly) coupled with the dosing device 2 by the jointed-arm robot 53, in particular with the control device 6 and the supply device 7, in order to produce an operative connection. The connection lines between the dosing device 2 and the mating interface portion 11 can, for example, be guided over cable tracks or inside the jointed-arm robot 53. The state shown here could, for example, represent a dosing operation of the dosing valve in the coupling module 20, wherein the coupling module 20, the work manipulator 53 and the dosing device 2 form a dosing entity. Distinct from what is shown here, the dosing device 2 could be connected with a plurality of such work manipulators 53.

FIG. 8 shows a coupling module 20 during storage in a magazine 50. As part of the valve interface portion 10 here, the coupling module 20 has two opposing grooves 27 (only one is visible) which are configured to suspend the coupling module 20 in the magazine 50. The magazine 50 here has, for example, only one storage location, wherein in the normal case, a plurality of coupling modules 20 or dosing valves can be stored at the same time. The valve interface portion 10 here has a diagrammatically shown RFID transponder in the form of a RFID chip 28 for identification or assignment of the dosing valve of the coupling module 20 by a work manipulator in the automated process. The magazine 50 here comprises a

RFID reader 54 associated with the storage location in order to read the RFID chip 28 of the coupling module 20 or of the dosing valve. The information read in this manner can be fed to a control device 6, rather than as shown here.

Finally, it is once again pointed out that the dosing valves described above in detail are merely exemplary embodiments which could be modified by the person skilled in the art in many different ways without departing from the scope of the invention. Thus, for example, the interface elements shown in the respective exemplary embodiments could also be present in multiples and/or be positioned differently. Furthermore, a combination of the interface elements shown is possible. Furthermore, the use of the indefinite articles “a” or “an” does not exclude the fact that multiples of the features involved could also be present.

### List of Reference Symbols

1 dosing unit
2 dosing device
3 dosing system
4 dosing valve
5 exchange system
6 control device
7 supply device
7′ maintenance device
8 maintenance coupling
9 multifunctional coupling
10 valve interface portion
10′, 10″, 10″′, 10* valve interface element
11 mating interface portion
11′, 11″, 11″′, 11* mating interface element
12 interface
13 coupling region
14, 14′ supply coupling element
15 supply coupling
16, 16′ function coupling element
17 function coupling
18, 18′ multifunctional coupling region
18″ multifunctional coupling
19, 19′ transport coupling element
19″ transport coupling
20 coupling module
21 housing
22 valve holder
23, 23′, 23″ sub-interface
24, 24′ sub-interface
25 connecting mechanism
25′ locking mechanism
26 sub-interface
27 groove
28 RFID-Chip
30 actuator unit
31 housing block
32 actuator chamber
33 action chamber
34 piezo actuator
35, 35′ contact pin
36 temperature sensor connections
36′ piezo actuator control connections
37 pressure piece
38 moving mechanism
39 lever
40 lever bearing
41 aperture
42 contact surface
44 control unit
46 cooling medium feed
46′ cooling medium discharge
47, 47′, 47″, 47″′ connection point
50 magazine
51 exchange device/exchange manipulator
52 maintenance coupling element
53 work manipulator
54 RFID reader
60 fluidic unit
61 ejection element/plunger
62 plunger tip
63 plunger head
64 contact surface
65 plunger spring
66 actuator spring
67 plunger bearing
68 plunger seal
69 seal seat
70 nozzle
71 nozzle opening
72 nozzle chamber
73 feed channel
74 frame portion
75 heating connector cable
76 medium pressure line
76′ medium line
77 heating control connector
78 EEPROM
79 heating device
80 dosing material cartridge
D data/control data
FS fluid flow
K tilt axis
KR coupling direction
SR ejection direction, dosing material/ejection movement direction, ejection element

1. A dosing unit (1) with at least one dosing device (2), the dosing device (2) having at least one dosing system (3) with at least one dosing valve (4) for the delivery of a dosing material, and with at least one exchange system (5) associated with the dosing device (2), wherein the dosing unit (1) is configured and controllable from a control device (6) in a manner such that in an automated process, at least the dosing valve (4) can be detachably coupled with the dosing device (2) via the exchange system (5) for the purposes of delivering dosing material and/or in a manner such that in an automated process, at least the dosing valve (4) can be detachably coupled with a supply device (7) via the exchange system (5).

2. The dosing unit as claimed in claim 1, wherein the exchange system (5) has at least one magazine (50) for at least one dosing valve (4) and wherein preferably
the magazine (50) is disposed in the dosing unit (1) in a stationary manner and wherein the dosing device (2) is movable in configuration and can be controlled by the control device (6) in a manner such that in the automated process, a dosing valve (4) in the magazine (50) is brought into operative contact with the dosing device (2) in order to couple the dosing valve (4) and/or in a manner such that in the automated process, a dosing valve (4) is deposited in the magazine (50), and/or
the magazine (50) is movable in configuration with respect to the dosing device (2) and can be controlled by the control device (6) in a manner such that in the automated process, a dosing valve (4) in the magazine (50) is brought into operative contact with the dosing device (2) in order to couple the dosing valve (4) and/or in a manner such that in the automated process, a dosing valve (4) is deposited in the magazine (50), and/or
the exchange system (5) has a movable exchange device (51, 53) which is configured and can be controlled by the control device (6) in a manner such that in the automated process, a transfer by the exchange device (51, 53) of at least one dosing valve (4) is carried out between the magazine (50) and the dosing device (2), in particular in a manner such that a dosing valve (4) from the magazine (50) is brought into operative contact with the dosing device (2) in order to couple the dosing valve (4) and/or in a manner such that a dosing valve (4) is transferred from the dosing device (2) into the magazine (50), and/or
a movable exchange device (53) of the exchange system (5) is configured and can be controlled by the control device (6) in a manner such that at least one dosing valve (4) is detachably coupled with the movable exchange device (53) for the purposes of delivering dosing material.

3. The dosing unit as claimed in claim 2, wherein the magazine (50) of the exchange system (5) has at least one maintenance coupling element (52) which cooperates with an associated coupling element (14, 16, 18) of the dosing valve (4) in order to form a maintenance coupling (8), wherein the maintenance coupling (8) is configured to connect at least one supply line (36′, 46, 75, 76, 76′) of the dosing valve (4) to a supply device (7), in particular to a maintenance device (7′), wherein preferably, via the maintenance coupling (8), a cleaner can be introduced into the dosing valve (4) and/or a heating device (79) of the dosing valve (4) can be controlled and/or a memory (78) associated with the dosing valve (4) can be read and/or the dosing valve (4) can be controlled by a control device (6).

4. The dosing unit as claimed in claim 2, wherein the magazine (50) of the exchange system (5) is configured to store different configurations of dosing valves (4), in particular at the same time, and/or
wherein the exchange system (5) and/or the dosing device (2) are configured and can be controlled by the control device (6) in a manner such that a specific dosing valve (4) from the magazine (50) is brought into operative contact with the dosing device (2) in order to couple the dosing valve (4).

5. An exchange system (5) for a dosing unit (1), in particular for a dosing unit (1) as claimed in claim 1, wherein the dosing unit (1) has at least one dosing device (2) with at least one dosing system (3), the dosing system (3) having at least one dosing valve (4), wherein the exchange system (5) is configured and can be controlled by a control device (6) in a manner such that in an automated process, at least the dosing valve (4) can be detachably coupled with the dosing device (2) via the exchange system (5) for the purposes of delivering dosing material and/or in a manner such that in an automated process, at least the dosing valve (4) can be detachably coupled with a supply device (7) via the exchange system (5),
wherein preferably, the exchange system (5) has a mating interface portion (11), which is configured in order to detachably couple a dosing valve (4) with the exchange system (5) in an automated process by cooperation with an associated valve interface portion (10) of the dosing valve (4).

6. A dosing device (2) for a dosing unit (1), in particular for a dosing unit (1) as claimed in claim 1, wherein the dosing device (2) has at least one dosing system (3) with at least one dosing valve (4) and wherein the dosing device (2) is configured and can be controlled from a control device (6) in a manner such that in an automated process, at least the dosing valve (4) can be detachably coupled with the dosing device (2) via an exchange system (5) for the purposes of delivering dosing material and/or in a manner such that in an automated process, at least the dosing valve (4) can be detachably coupled with a supply device (7) via an exchange system (5).

7. A dosing valve (4) for a dosing system (3), in particular for a dosing unit (1) as claimed in claim 1,
wherein the dosing valve (4) has a valve interface portion (10) which is configured to detachably couple the dosing valve (4) with a dosing device (2) and/or with a supply device (7) in an automated process by cooperation with an associated mating interface portion (11) which is associated with the dosing device (2) and/or the supply device (7), and
wherein the dosing valve (4) has a coupling region (13, 19) which, in order to couple the dosing valve (4) with the dosing device (2) and/or with the supply device (7) in an automated process, is configured to interact with an exchange system (5) which is at least temporarily associated with the dosing valve (4).

8. The dosing valve as claimed in claim 7, wherein the valve interface portion (10) and/or the mating interface portion (11) is formed in multiple parts, and/or
wherein the valve interface portion (10) has a supply coupling element (14) for forming a supply coupling (15), the supply coupling (15) being configured in order to couple, during operation, at least one supply line (36′, 46, 75, 76, 76′) of the dosing valve (4) with a supply device (7), preferably with the dosing device (2), and/or
wherein the valve interface portion (10) has a function coupling element (16) and wherein a mating interface portion (11) cooperating with the valve interface portion (10) has a further function coupling element (16′) for forming a function coupling (17) and wherein the valve interface portion (10) and/or the mating interface portion (11) is configured to detachably couple the dosing valve (4) with an associated coupling partner (2, 5, 53) via an interaction between the valve interface portion (10) and the mating interface portion (11), and/or
wherein the valve interface portion (10) has a transport coupling element (19) and wherein a mating interface portion (11) cooperating with the valve interface portion (10) having a further transport coupling element (19′) for forming a transport coupling (19″) is associated with an exchange system (5), and wherein the valve interface portion (10) and/or the mating interface portion (11) is configured to detachably couple the dosing valve (4) with the exchange system (5) via an interaction between the valve interface portion (10) and the mating interface portion (11).

9. The dosing valve as claimed in claim 7-or claim 8, wherein the coupling region (13, 19) of the dosing valve (4) is part of the valve interface portion (10), wherein preferably, the coupling region (13) is formed by the function coupling element (16), and/or
wherein the supply coupling element (14) and/or the function coupling element (16) and/or the coupling region (13) form a multifunctional coupling region (18) for forming a multifunctional coupling (18″).

10. The dosing valve as claimed in claim 7, with a connecting mechanism (25) comprising a first function coupling element (16) and/or a second function coupling element (16′), wherein the connecting mechanism (25) comprises an electrical coupling mechanism and/or a pneumatic coupling mechanism and/or a hydraulic coupling mechanism and/or a mechanical coupling mechanism, and/or
wherein the connecting mechanism (25) has a preferably controllable locking mechanism (25′) for interlocking the two function coupling elements (16, 16′), wherein preferably, the locking mechanism (25′) is configured as part of a mating interface portion (11), in particular as part of a dosing device (2) or as part of an exchange system (5, 53).

11. The dosing valve as claimed in claim 8, wherein the supply coupling element (14) and/or the transport coupling element (19) is configured to produce at least one, preferably a plurality of electrical and/or mechanical and/or signalling and/or pneumatic and/or fluid-conducting connection (36′, 46, 75, 76, 76′) via the supply coupling (15) and/or via the transport coupling (19″), and/or
wherein the supply coupling element (14) comprises a closing mechanism which is configured to close at least one supply line (46, 76, 76′) leading to the dosing valve (4), in particular to a fluidic unit (60) of the dosing valve (4), in a gas-tight and/or liquid-tight manner,
and/or
wherein the supply coupling element (14) is configured to cooperate with a maintenance coupling element (52) of a magazine (50) of an exchange system (5) in order to form a maintenance coupling (8), wherein the maintenance coupling (8) is configured to connect at least one supply line (36′, 46, 75, 76, 76′) of the dosing valve (4) to a supply device (7), in particular to a maintenance device (7′).

12. The dosing valve as claimed in claim 8, wherein the transport coupling (19″) is configured to detachably couple the dosing valve (4), in particular during a transport of the dosing valve (4) in the dosing unit (1), with an associated supply device (7),
and/or
wherein the transport coupling element (19) and/or the function coupling element (16) and/or the supply coupling element (14) is configured and/or disposed such that the dosing valve (4) can be coupled with an associated coupling partner (2, 5, 6, 7, 51, 53) simultaneously via the transport coupling element (19) and/or via the function coupling element (16) and/or via the supply coupling element (14).

13. The dosing valve as claimed in claim 7, wherein the valve interface portion (10), in particular the transport coupling element (19) and/or the function coupling element (16) and/or the supply coupling element (14) and/or the coupling region (13), is formed as part of the dosing valve (4), in particular as an integral component.

14. A dosing system (3) for a dosing device (2) of a dosing unit (1), in particular for a dosing unit (1), wherein the dosing system (3) has a dosing valve (4), in particular a dosing valve (4) as claimed in claim 7, and an associated control device (6, 44) for controlling the dosing valve (4), wherein the dosing system (3) is configured and can be controlled by a control device (6, 44) in a manner such that, in an automated process, at least the dosing valve (4) can be detachably coupled with the dosing device (2) via an exchange system (5) of the dosing unit (1) for the purposes of delivering dosing material and/or in a manner such that, in an automated process, at least the dosing valve (4) can be detachably coupled with a supply device (7) via the exchange system (5).

15. A method for the automated coupling of at least one dosing valve (4) with a dosing device (2) and/or with a supply device (7), preferably a dosing valve (4) for a dosing unit (1) as claimed in claim 1, wherein the automated coupling preferably comprises at least one exchange of a dosing valve (4) and/or is carried out during operation of a dosing unit (1), wherein the method comprises at least the following steps:
providing at least one dosing valve (4) with a valve interface portion (10), preferably by means of an exchange system (5),
using the exchange system (5) to bring the valve interface portion (10) of the dosing valve (4) together with a mating interface portion (11) which is associated with a dosing device (2) and/or a supply device (7),
interlocking at least one interface element (10′, 10″, 10*, 11′, 11″, 11*) of the valve interface portion (10) and/or of the mating interface portion (11), preferably by means of a control device (6), in order to detachably couple the dosing valve (4) via the valve interface portion (10) with the mating interface portion (11) associated with the dosing device (2) and/or the supply device (7) for coupling the dosing valve (4),
optionally, adjusting an actuator (34) of an actuator unit (30) in a manner such that in a defined operational state of the actuator (34), in particular in a deflected operational state, a specific contact pressure of an ejection element (61) is produced in a nozzle (70) by the actuator (34), wherein the adjustment process is preferably controlled by means of the control device (6).
